(19) United States
(12) Patent Application Publication
(10) Pub. No.: US 2009/0148348 A1
(43) Pub. Date: Jun. 11, 2009

(54) PLASTIC SURFACES AND APPARATUSES FOR REDUCED ADSORPTION OF SOLUTES AND METHODS OF PREPARING THE SAME

(75) Inventors: Kenneth I. Pettigrew, Sutherland, VA (US); Pang-Jen Craig Kung, Cary, NC (US); Joshua T. Stecher, Malvern, PA (US); Gregory Fenton Smith, Durham, NC (US); Hugh C. Crenshaw, Durham, NC (US)

Correspondence Address: EKSIGENT TECHNOLOGIES, LLC;c/o SHELDON MAK ROSE & ANDERSON, 100 East Corson Street, Third Floor, PASADENA, CA, 91103-3842, US

(73) Assignee: EKSIGENT TECHNOLOGIES, LLC, Dublin, CA (US)

(21) Appl. No.: 11/719,531

(22) PCT Filed: Aug. 10, 2006
(86) PCT No.: PCT/US06/31163

§ 371 Date: May 16, 2007

Related U.S. Application Data
(60) Provisional application No. 60/707,288, filed on Aug. 11, 2005.

(51) Int. Cl. B01L 3/00; B05D 3/00

(52) U.S. Cl. 422/99; 427/2.11

(57) ABSTRACT

A method of treating a plastic surface with fluorine gas to decrease adsorption of hydrophobic solute molecules to the surface is provided. The method can include treating a surface with a first gas comprising fluorine gas and a second gas comprising oxygen gas, water vapor, or both oxygen gas and water vapor. Plastics treated using the method provide useful drug discovery and biochemical tools for the testing, handling, and storage of solutions containing low concentrations of hydrophobic solutes. Microfluidic devices containing treated plastic interior surfaces and methods of using such devices to make concentration-dependent measurements are also described.

### CROSS-REFERENCE TO RELATED APPLICATIONS

This application claims the benefit of U.S. Patent Application Ser. No. 60/707,288, filed Aug. 11, 2005, the disclosure of which is incorporated herein by reference in its entirety. The disclosures of the following U.S. Provisional Applications, commonly owned and simultaneously filed Aug. 11, 2005, are all incorporated by reference in their entirety: U.S. Provisional Application entitled MICROFLUIDIC APPARATUS AND METHOD FOR SAMPLE PREPARATION AND ANALYSIS, U.S. Provisional Application 60/707,373 (Attorney Docket No. 447/2/1); U.S. Provisional Application entitled APPARATUS AND METHOD FOR HANDLING FLUIDS AT NANO-SCALE RATES, U.S. Provisional Application No. 60/707,421 (Attorney Docket No. 447/99/212); U.S. Provisional Application entitled MICROFLUIDIC BASED APPARATUS AND METHOD FOR THERMAL REGULATION AND NOISE REDUCTION, U.S. Provisional Application No. 60/707,330 (Attorney Docket No. 447/99/2/3); U.S. Provisional Application entitled MICROFLUIDIC METHODS AND APPARATUSES FOR FLUID MIXING AND VALVING, U.S. Provisional Application No. 60/707,329 (Attorney Docket No. 447/99/2/4); U.S. Provisional Application entitled METHODS AND APPARATUSES FOR GENERATING A SEAL BETWEEN A CONDUIT AND A RESERVOIR WELL, U.S. Provisional Application No. 60/707,286 (Attorney Docket No. 447/99/2/5); U.S. Provisional Application entitled MICROFLUIDIC SYSTEMS, DEVICES AND METHODS FOR REDUCING DIFFUSION AND COMPLIANCE EFFECTS AT A FLUID MIXING REGION, U.S. Provisional Application No. 60/707,220 (Attorney Docket No. 447/99/3/1); U.S. Provisional Application entitled MICROFLUIDIC SYSTEMS, DEVICES AND METHODS FOR REDUCING NOISE GENERATED BY MECHANICAL INSTABILITIES, U.S. Provisional Application No. 60/707,245 (Attorney Docket No. 447/99/3/2); U.S. Provisional Application entitled MICROFLUIDIC SYSTEMS, DEVICES AND METHODS FOR REDUCING BACKGROUND AUTOFLUORESCENCE AND THE EFFECTS THEREOF, U.S. Provisional Application No. 60/707,386 (Attorney Docket No. 447/9913/3); U.S. Provisional Application entitled MICROFLUIDIC CHIP APPARATUSES, SYSTEMS, AND METHODS HAVING FLUIDIC AND FIBER OPTIC INTERCONNECTIONS, U.S. Provisional Application No. 60/707,246 (Attorney Docket No. 447/99/4/2); U.S. Provisional Application entitled METHODS FOR CHARACTERIZING BIOLOGICAL MOLECULE MODULATORS, U.S. Provisional Application No. 60/707,328 (Attorney Docket No. 447/99/5/1); U.S. Provisional Application entitled METHODS FOR MEASURING BIOCHEMICAL REACTIONS, U.S. Provisional Application No. 60/707,370 (Attorney Docket No. 447/99/5/2); U.S. Provisional Application entitled METHODS AND APPARATUSES FOR REDUCING EFFECTS OF MOLECULE ADSORPTION WITHIN MICROFLUIDIC CHANNELS, U.S. Provisional Application No. 60/707,366 (Attorney Docket No. 447/99/8); U.S. Provisional Application entitled BIOCHEMICAL. ASSAY METHODS, U.S. Provisional Application No. 60/707,374 (Attorney Docket No. 447/99/10); U.S. Provisional Application entitled FLOW REACTOR METHOD AND APPARATUS, U.S. Provisional Application No. 60/707,233 (Attorney Docket No. 447/99/11); and U.S. Provisional Application entitled MICROFLUIDIC SYSTEM AND METHODS, U.S. Provisional Application No. 60/707,384 (Attorney Docket No. 447/99/12).

### TECHNICAL FIELD

The present disclosure generally relates to methods for reducing the adsorption of hydrophobic molecules to plastic surfaces, methods for preparing drug discovery and biochemical tools and packaging material having reduced ability to adsorb hydrophobic solute molecules, and the tools and packaging material themselves. More particularly, the present disclosure relates to microfluidic chips and systems having reduced ability to adsorb hydrophobic solute molecules, capable of producing continuous concentration gradients, and the use of the systems in making concentration-dependent measurements.

### Abbreviations

μl=microliter
μm=micrometer
μM=micromolar
° C.=degrees Celsius
ABS=acrylonitrile butadiene styrene
CaCO₃=calcium carbonate (limestone)
CD-ROM=compact disc read-only memory
cm=centimeter
COC=cyclic olefin copolymer(s)
DVD=digital versatile disc
EC₅₀=50% effective concentration
EPROM=erasable programmable read-only memory
F=fluorine
F₂=molecular fluorine
HDPE=high-density polyethylene
HF=hydrofluoric acid
IC₅₀=50% inhibitory concentration
IR=infrared
m=meters
min minute
mm=millimeter
nl=nanoliter
nM=nanomolar
PA=polyamide
PBT=polybutyleneterephthalate
PC=polycarbonate
PDMS=polydimethylsiloxane
PE=polyethylene
PEEK=polyetheretherketone
PEG=polyethylene glycol
PEI=polyetherimide
PEO=polyethylene oxide
PET=polyethylene terephthalate
PMMA=polymethylmethacrylate
POM=polyoxymethylene
PP=polypropylene
PPE=polyphenylene ether
PPO=polypropylene oxide
PROM=programmable read-only memory
PS=polystyrene
psi=pounds per square inch
PVC=polyvinyl chloride
PVDF=polyvinylidene fluoride
PVTMS=poly(vinyltrimethylsilane)
RAM=random access memory
RF=radio frequency
S/V=surface area to volume ratio

### BACKGROUND ART

Microfluidic devices developed in the early 1990s were fabricated from hard materials, such as silicon and glass, using photolithography and etching techniques (Ouellette, 2003; Quake and Scherer, 2000). Photolithography and etching techniques, however, are costly and labor intensive, require clean-room conditions, and pose several disadvantages from a materials standpoint. For these reasons, soft materials, such as plastics, have emerged as alternative materials for microfluidic device fabrication. The use of plastics has made possible the manufacture and actuation of devices containing valves, pumps, and mixers (Ouellette, 2003; Quake and Scherer, 2000; Unger et al., 2000; McDonald and Whitesides, 2002; Thorsen et al., 2002). The variety of plastic materials that have been used for the fabrication of microfluidic devices includes polyamide (PA), polybutyleneterephthalate (PBT), polycarbonate (PC), polyethylene (PE), polymethylmethacrylate (PMMA), polyoxymethylene (POM), polypropylene (PP), polyphenylene ether (PPE), polystyrene (PS), polydimethylsiloxane (PDMS), polyetheretherketone (PEEK) and polyetherimide (PEI) (Becker and Gärtner, 2000).

The increasing complexity of microfluidic devices has created a demand to use such devices in a rapidly growing number of applications. To this end, the use of soft materials has allowed microfluidics to develop into a useful technology that has found application in genome mapping, rapid separations, sensors, nanoscale reactions, ink-jet printing, drug delivery, Lab-on-a-Chip, in vitro diagnostics, injection nozzles, biological studies, and drug screening (Ouellette, 2003; Quake and Scherer, 2000; Unger et al., 2000; McDonald and Whitesides, 2002; Thorsen et al., 2002; and Liu et al., 2003).

The miniaturization of drug testing techniques promised by microfluidics potentially represents great cost and time savings for the drug industry by reducing the amount of drug candidate and other reagents needed for testing, by reducing waste, and by reducing the number of separate handling steps involved in a particular assay. Miniaturization does, however, come with its own set of technical issues. For example, many measurements in drug discovery rely on knowledge of the concentration of a test molecule. Examples of such measurements include EC₅₀, IC₅₀, and enzyme kinetics measurements. Many drug molecules are organic compounds that are relatively hydrophobic, making them likely to adhere to the walls of microfluidic devices made from the generally hydrophobic plastics currently used in their fabrication. An important consequence of miniaturization is that the ratio of surface area to volume in microfluidic and other miniaturized systems is many orders of magnitude larger than is found in conventional drug discovery tools. Thus, adsorption of test molecules and other reagents to device walls can have more serious consequences on sample concentrations than it can in conventional, non-miniaturized devices. Changes in concentration can be further accelerated by the short diffusion distances from points within the volume of a test solution to the walls of the miniaturized devices. All in all, these issues mean that the adsorption of solute molecules in microfluidic systems and other miniaturized devices can be an obstacle to the use of those systems and devices when concentration control is a consideration.

The problem of compound adsorption to surfaces potentially affects devices other than microfluidic channels. For example, drug compounds and biological and environmental test samples are typically stored, mixed, transferred, and studied in many different components, such as pipette tips, microwells (such as in microtiter plates), tubes, vials, and others, all of which are or can be made from plastics. The adsorption of compounds to the surfaces of these components can affect the concentrations of those compounds in solution, especially if the concentration is low, for example in the study of more potent compounds, or if the volume is small, which generally means the surface to volume ratio becomes larger.

Thus, there is a need for materials with improved surface characteristics to provide better drug discovery tools and biochemical and environmental testing equipment that are more capable of accurately handling samples with low hydrophobic solute concentrations or small volumes.

### SUMMARY

According to one embodiment, a method is disclosed for treating plastic surfaces with a first gas comprising fluorine gas and a second gas comprising oxygen gas, water vapor, or a combination of oxygen gas and water vapor, the treatment making the surfaces less likely to adsorb hydrophobic solutes. In some embodiments, the method comprises treating the plastic surface with a mixture of fluorine gas and an inert gas for a period of time, and then flushing the surface with air, the overall process making the surface more hydrophilic. The plastic surface can be pretreated by being placed under vacuum and/or by being exposed to air or an inert gas environment. In some embodiments, the plastic surface comprises the interior surface of a microfluidic chip or one or more surfaces of a microtiter plate, a pipette, a micropipette tip, a tube, a syringe, a storage vessel, or a length of tubing.

In a second embodiment, the presently disclosed subject matter provides plastic articles with treated surfaces, the treated surfaces having a reduced ability to adsorb hydrophobic solutes. In some embodiments, the hydrophobic solute will be a drug molecule. In some embodiments, the hydrophobic solute will have a log P greater than about 3. Thus, it is one object of the presently disclosed subject matter to provide improved plastic articles for use in drug discovery, medical diagnostics, biochemical and environmental sample testing, and as packaging material useful in storing solutions containing hydrophobic solutes. In some embodiments, the treated plastic article comprises one of a microtiter plate, a pipette, a micropipette tip, a tube, a syringe, a storage vessel, or a length of tubing.

In a third embodiment, the presently disclosed subject matter provides a microfluidic chip containing one or more microfluidic channels with a treated plastic interior surface, the surface having a reduced ability for adsorbing hydrophobic solutes. In some embodiments, the microfluidic chip is part of an apparatus that further comprises one or more pumps, and an analytical signal detection system. In some embodiments, the apparatus comprises at least three pumps, three solution input channels, two mixing chambers and an analysis channel. In some embodiments, the analysis channel has larger dimensions than the channels upstream from the analysis channel. In some embodiments, the system will be capable of producing continuous concentration gradients of one or more solutions.

In a fourth embodiment, the presently disclosed subject matter provides a method of determining a concentration-dependent characteristic of the interaction of two molecules, the method comprising the use of a microfluidic system having one or more treated plastic surfaces characterized by a reduced capacity for the adsorption of hydrophobic molecules. In some embodiments, the concentration-dependent characteristic is a measurement of drug potency. In some embodiments, the measurement is related to enzyme kinetics.

Accordingly, it is an object of the presently disclosed subject matter to provide novel methods for treating plastic surfaces and novel plastic articles with treated surfaces. This and other objects are achieved in whole or in part by the presently disclosed subject matter.

### BRIEF DESCRIPTION OF THE DRAWINGS

FIG. 1 is a schematic diagram of an exemplary embodiment of a system for treating the interior surfaces of a microfluidic chip with fluorine gas.

FIG. 2 is a schematic diagram of an exemplary embodiment of a microfluidic system for generating and mixing continuous concentration gradients of fluids.

FIG. 3 is a schematic diagram of the top view of an analysis channel of a microfluidic chip, wherein the analysis channel has enlarged dimensions.

FIG. 4A is a schematic diagram of the side view of an analysis channel of a microfluidic chip, wherein the analysis channel has enlarged dimensions.

FIG. 4B shows cross-sectional views of the analysis channel shown in FIG. 4A at points A-A and B-B.

FIG. 5 is a plot showing the relationship between the time of exposure to fluorine of a polymer surface and the contact angle formed on that surface by a drop of water.

FIG. 6 is a plot of the response of an enzyme to an inhibitory molecule when the inhibitory molecule adsorbs to the surface of the microfluidic chip in which the experiment was performed.

FIG. 7 is a plot of inhibitor concentration versus enzyme activity derived from the experiment shown in FIG. 6.

FIG. 8A is a schematic diagram showing adsorption of an inhibitor molecule to a surface and how that adsorption can alter the free concentration of the molecule relative to a tracer dye molecule.

FIG. 8B is a schematic diagram showing desorption of an inhibitor molecule from a surface and how that desorption can alter the free concentration of the molecule relative to a tracer dye molecule.

FIG. 9 is a plot of the response of an enzyme to an inhibitory molecule when the inhibitory molecule adsorbs to the surface of the microfluidic chip in which the experiment was performed and when adsorption of the inhibitor molecule to the surface is reduced.

FIG. 10 is a plot of inhibitor concentration versus enzyme activity derived from the experiment shown in FIG. 9 in which the adsorption of the inhibitory molecule to the surface is reduced.

### DETAILED DESCRIPTION

The presently disclosed subject matter will now be described more fully hereinafter with reference to the accompanying Drawings and Examples, in which representative embodiments are shown. The presently disclosed subject matter can, however, be embodied in different forms and should not be construed as limited to the embodiments set forth herein. Rather, these embodiments are provided so that this disclosure will be thorough and complete, and will fully convey the scope of the embodiments to those skilled in the art.

Unless otherwise defined, all technical and scientific terms used herein have the same meaning as commonly understood by one of ordinary skill in the art to which this presently described subject matter belongs. All publications, patent applications, patents, and other references mentioned herein are incorporated by reference in their entirety.

Throughout the specification and claims, a given chemical formula or name shall encompass all optical and stereoisomers, as well as racemic mixtures where such isomers and mixtures exist.

### I. Definitions

Following long-standing patent law convention, the terms “a”, “an”, and “the” refer to “one or more” when used in this application, including the claims. Thus, for example, reference to “a microfluidic channel” includes a plurality of such microfluidic channels, and so forth.

The term “about” as used herein, when referring to a value or to an amount of mass, weight, time, volume, or percentage is meant to encompass variations of ±20% or ±10%, more preferably ±5%, even more preferably ±1%, and still more preferably ±0.1% from the specified amount, as such variations are appropriate to perform the disclosed method.

As used herein, the term “fluid” generally means any flowable medium such as liquid, gas, vapor, supercritical fluid, combinations thereof, or the ordinary meaning as understood by those of skill in the art.

As used herein, the term “vapor” generally means any fluid that can move and expand without restriction except for at a physical boundary such as a surface or wall, and thus can include a gas phase, a gas phase in combination with a liquid phase such as a droplet (e.g., steam), a supercritical fluid, the like, or the ordinary meaning as understood by those of skill in the art.

As used herein, the term “solute” means a material dissolved and/or suspended into a liquid material comprising the “solvent” of a solution. The solute may become free molecules dissolved in the solute. However, the term “solute” as used herein further includes materials suspended in a “solvent”, such as for example occurs with material in colloidal suspensions. Solvents can include water and aqueous solutions (including solutions of buffers, salts, detergents, and other water-soluble components), water miscible organic solvents, non-water miscible organic solvents, and combinations thereof. As used herein, the term “reagent” generally means any flowable composition or chemistry. The result of two reagents combining together is not limited to any particular response, whether a biochemical reaction, a biological response, a dilution, or the ordinary meaning as understood by those of skill in the art.

As used herein, the term “computer-readable medium” refers to any medium that participates in providing instructions to the processor of a computer for execution. Such a medium may take many forms, including but not limited to, non-volatile media, volatile media, and transmission media. Non-volatile media include, for example, optical or magnetic disks. Volatile media include dynamic memory, such as the main memory of a personal computer, a server or the like. Transmission media include coaxial cables; copper wire and fiber optics, including the wires that form the bus within a computer. Transmission media can also take the form of electric or electromagnetic signals, or acoustic or light waves such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave transporting data or instructions, or any other computer-readable medium. Various forms of computer readable media may be involved in carrying one or more sequences of one or more instructions to the processor for execution. Alternatively, hard-wired circuitry may be used in place of or in combination with software instructions to implement the subject matter. Thus, embodiments of the subject matter are not limited to any specific combination of hardware circuitry and software.

As used herein, the term “microfluidic chip,” “microfluidic system,” or “microfluidic device” generally refers to a chip, system, or device which can incorporate a plurality of interconnected channels or chambers, through which materials, and particularly fluid borne materials can be transported to effect one or more preparative or analytical manipulations on those materials. A microfluidic chip is typically a device comprising structural or functional features dimensioned on the order of mm-scale or less, and which is capable of manipulating a fluid at a flow rate on the order of several μl/min or less. Such features generally include, but are not limited to channels, fluid reservoirs, reaction chambers, mixing chambers, and separation regions. Typically, such channels, chambers and regions include at least one cross-sectional dimension that is in a range of from about 1 μm to about 500 μm. The use of dimensions on this order allows the incorporation of a greater number of channels or chambers in a smaller area, and utilizes smaller volumes of reagents, samples, and other fluids for performing the preparative or analytical manipulation of the sample that is desired.

Microfluidic systems are capable of broad application and can generally be used in the performance of biological and biochemical analysis and detection methods. The systems described herein can be employed in research, diagnosis, environmental assessment and the like. In particular, these systems, with their micron scales, nanoliters volumetric fluid control systems, and integratability, can generally be designed to perform a variety of fluidic operations where these traits are desirable or even required. In addition, these systems can be used in performing a large number of specific assays that are routinely performed at a much larger scale and at a much greater cost.

A microfluidic device or chip can exist alone or may be a part of a microfluidic system which, for example and without limitation, can include: pumps for introducing fluids, e.g., samples, reagents, buffers and the like, into the system; detection equipment or systems; data storage systems; and control systems for controlling fluid transport and/or direction within the device, monitoring and controlling environmental conditions to which fluids in the device are subjected, e.g., temperature, current and the like.

As used herein, the terms “channel,” “microscale channel,” and “microfluidic channel” are used interchangeably and can mean a recess or cavity formed in a material by imparting a pattern from a patterned substrate into a material or by any suitable material removing technique, or can mean a recess or cavity in combination with any suitable fluid-conducting structure mounted in the recess or cavity, such as a tube, capillary, or the like.

As used herein, the term “communicate” (e.g., a first component “communicates with” or “is in communication with” a second component) and grammatical variations thereof are used to indicate a structural, functional, mechanical, electrical, optical, or fluidic relationship, or any combination thereof, between two or more components or elements. As such, the fact that one component is said to communicate with a second component is not intended to exclude the possibility that additional components can be present between, and/or operatively associated or engaged with, the first and second components.

In referring to the use of a microfluidic device for handling the containment or movement of fluid, the terms “in”, “on”, “into”, “onto”, “through”, and “across” the device generally have equivalent meanings.

As used herein, the terms “adsorb” or “adsorption” refer to the ability of a molecule, in particular a solute molecule, to interact with or adhere to the surface of another substance, in particular the surface of a solid, such as the wall of a channel, tube, or container. Hydrophobic molecules might adsorb to a hydrophobic surface, for example, through Van der Waals forces. Unlike adsorption, which is a surface phenomena, the terms “absorb”, “absorption”, “penetrate”, or “penetration” refer to the ability of a molecule to be taken into another substance.

As used herein, the term “tube” refers to a container having at least one roughly cylindrical part. Thus, tubes can include items, such as test tubes, centrifuge tubes, and the like. As used herein, the term “tubing” or “length of tubing” refers to a hollow material through which a liquid or gas may flow. Tubing is open at both ends of its length. Tubing can include capillary tubing.

The term “drug” or “known drug” as used herein refers to a molecule that by itself or in combination with other drugs or formulation components is used to treat or prevent a disease or disorder or a symptom of a disease or disorder. Drugs may be for human or animal use. The term “potential drug” as used herein refers to a molecule that is suspected of being able to modulate a biological activity or state in a subject, including but not limited to, treating or preventing a disease or disorder or a symptom of a disease or disorder. A potential drug may also simply be any molecule that is being tested to determine if it has an activity capable of modulating a biological activity or state in a subject, including but not limited to, treating a disease or disorder or a symptom of a disease or disorder.

As used herein, the term “fluorine gas” refers to F₂. The term “oxygen gas” refers to O₂. The term “fluorine gas mixture” refers to a mixture of gases, wherein one of the gases is F₂. The use of the term “gas” without any other designation includes gaseous mixtures of different molecular species, as well as gas that includes molecules of a single molecular species. When components of gas mixtures are described as being a certain percentage of the mixture, the percentage will be the percentage of volume of that component versus the entire volume.

The term “air” as used herein refers to a gaseous composition that at sea level generally contains about 78% nitrogen gas (N₂), 21% oxygen gas (O₂), 0.94% argon gas (Ar₂), and 0.03% carbon dioxide (CO₂), or its equivalent at other atmospheric pressures and in other natural and artificial environments. Air can contain trace amounts of other chemicals, which can include compounds such as neon (Ne₂), hydrogen (H₂), helium (He₂), krypton (Kr₂), xenon (Xe₂), sulfur dioxide (SO₂), methane (CH₄), nitrous oxide (N₂O), nitrogen dioxide (NO₂), iodine vapor (I₂), carbon monoxide (CO), ammonia (NH₃). Air can also contain water vapor. The amount of water vapor present in the air can depend on temperature. The term “air” can include dry air and compressed air, in which water vapor is present only in trace amounts.

As used herein, the term “hydrophilic” refers to the capacity of a molecule, solvent, solute, or surface to interact with polar substances, particularly water. The terms “hydrophobic” and “lipophilic” as used herein, refer to the preference of a molecule, solute, solvent or surface to interact with other molecules, solutes, solvents or surfaces that are electrically neutral and relatively nonpolar. Some molecules can be described as hydrophobic, yet still be soluble in water. LogP is the log of the partition coefficient (octanol to water) for a molecule and can be used as a measurement of a molecule's hydrophobicity or hydrophilicity. If a molecule has a logP of 3, 1000 times more compound will partition into the octanol fraction than the water fraction. The higher the logP, the more hydrophobic the molecule. The term “clogP” refers to a calculated logP as opposed to an experimentally determined logP.

As used herein, the term “plastic” refers to a material containing one or more organic polymers that under the appropriate conditions of temperature and pressure, can be molded or shaped. In their finished states plastics are solids. Examples of plastics include, but are not limited to, polycarbonates, polyethylene, polypropylene, polystyrene, polyaryletheretherketone, polybutene, polyamide (nylon), siloxanes such as polydimethylsiloxane (PDMS), polyesters such as polybutylene terephthalate (PBT), and polyethylene terephthalate (PET), polyphenylene sulfide, polyvinyl chloride, cellulosics, polyphenylene oxide, polymethylpentene, polytetrafluoroethylene (PTFE), and the like. The term “plastics” further encompasses combinations of different types of polymers, including graft copolymers and block copolymers, such as, for example, cyclic olefin copolymers (COC) and acrylonitrile butadiene styrene (ABS).

Plastics can be classified according to the type of chemical bond formed between the monomer units making up the polymeric material or according to the type of monomer itself. Thus, plastics can include polyolefins, which are formed from monomers containing double bonds. Examples of polyolefins include polyethylene and polypropylene. Polyaryls are plastics comprising arene monomers, for example polystyrene. Polyurethanes comprising monomers bonded together by carbamate bonds, (N—C(═O)—O).

The term “polycarbonates” or “a polycarbonate” are used herein to refer to polymers wherein the linkage from one monomer to another is a carbonate bond, (O—C(═O)—O). The term “polycarbonate” refers herein to the most common of the polycarbonates, that formed from Bisphenol A. Thus, polycarbonate has the structure:

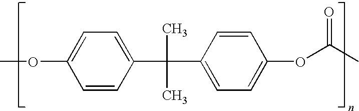

As used herein, the terms “surface tension” and “surface energy” refer to the enhancement of intermolecular attractive forces that occurs at the surface of a liquid or solid. Molecules at the surfaces of liquids and solids, which do not have the balancing factor of the cohesive forces of other molecules on all sides of them, tend to exhibit stronger attractive forces upon their nearest neighbor molecules on the surface. For example, surface tension makes it harder to move an object through the surface of a liquid than to move it when it is completely submerged. Surface tension is generally measured in terms of dynes/cm, where one dyne is the force required to accelerate the mass of one gram at a rate of one centimeter per second squared. Water at room temperature has a surface tension of 72.8 dynes/cm, while ethyl alcohol has a surface tension of 22.3 dynes/cm. Thus, more hydrophilic substances have higher surface tensions or surface energies. Many plastics have hydrophobic surfaces, possessing surface energies of 30 to 40 dyne/cm. Most fluorinated surfaces, such as TEFLON® (Dupont, Wilmington, Del., USA), are highly hydrophobic—TEFLON® has a surface energy of about 15 dyne/cm.

As used herein, the term “wettability” refers to the ability of a surface to interact with a liquid. Wettability is generally measured by the contact angle (θ) formed when a drop of liquid is placed on the surface. The contact angle is the angle formed between the solid/liquid interface and the side of the liquid droplet (the liquid/vapor interface). If molecules of the liquid have a stronger attraction to the molecules of the solid surface than to each other, the liquid spreads over the surface, creating a relatively flat droplet with a small contact angle. Liquids are said to “wet” a surface if the contact angle between a droplet of the liquid and the surface is less than 90 degrees. If the liquid molecules are more strongly attracted to each other than to the surface, the liquid beads up and does not wet the solid. Wettability can be used to assess the hydrophobicity or hydrophilicity of a surface in that surfaces that are wet by hydrophilic liquids, like water, are themselves hydrophilic. Surfaces that are wet by hydrophobic liquids, such as nonpolar organic solvents are themselves more hydrophobic.

### II. General Considerations

II.A. Surface Modification

One approach to decrease the adsorption of solutes to surfaces is to treat the surface, either through covalent attachment or non-covalent adsorption of other molecules, to change the physiochemical properties of the surface. A review of surface treatments with regard to capillary electrophoresis has been published recently (Doherty et al., 2003). Alterations of surface chemistry have been used to control the adsorption, or “sticking”, of proteins (Locascio et al., 1999; Rossier et al., 2000; Yang and Sundberg, 2001; Henry et al., 2002; Becker and Locascio, 2002). The most common approach taken for proteins in microfluidic and other miniaturized systems has been to “PEGylate” the surface, covalently attaching a layer of polyethylene glycol (PEG) to the surface (e.g. Yang and Sundberg, 2001). PEGylation covers the surface with a hydrophilic material that prevents adsorption of many biological proteins and cells (prokaryotic and eukaryotic). Similar approaches have used detergents, especially non-ionic detergents, like the block copolymers called “pluronics” manufactured by BASF (Florham Park, N.J., USA) composed of blocks of polyethylene oxide-polypropylene oxide-polyethylene oxide (PEO-PPO-PEO) in which the hydrophilic PEO is similar to PEG (Desai and Hubbell, 1991a; Desai and Hubbell, 1991b; Desai and Hubbell, 1991c; Bridgett et al., 1992; Desai and Hubbell, 1992; Desai et al., 1992; Tan et al., 1993; Dewez et al., 1996; Dewez et al., 1997; Green et al., 1998; Detrait et al., 1999; Bromberg and Salvati, Jr., 1999; O'connor et al., 2000; Bevan and Prieve, 2000; Webb et al., 2001; Bohner et al., 2002; Liu et al., 2002; Brandani and Stroeve, 2003; De Cupere et al., 2003; Musoke and Luckham, 2004).

Fluorination is another surface modification to alter surface properties. A variety of fluorination techniques have been used to fluorinate the surfaces of miniaturized devices. Organosilane chemistry has been used to introduce perfluoroalkyl groups (Cheng et al., 2004) and fluoralkyl groups to surfaces through covalent linkages (Li et al., 2003). Chemical vapor deposition using chemicals such as hexafluoropropylene and octafluorocyclobutane has been employed to coat surfaces with fluorocarbon films (Andersson et al., 2001; Moon et al., 2002; Bayiati et al., 2004; Auerswald et al., 2004). Some groups have fabricated microfluidic devices directly from fluorinated polymers themselves (Lee et al., 1998; Wood et al., 2004; Davidson and Lowe, 2004; Rolland et al., 2004).

Typically, fluorination techniques serve to make the polymer surface hydrophobic, and adsorption of hydrophobic molecules frequently occurs when the surface is hydrophobic. Many molecules studied in drug discovery are hydrophobic. Indeed, a large proportion of the prospective drug molecules in most pharmaceutical companies' pipelines have clogP values greater than 3, indicating that they are highly hydrophobic. Thus, many molecules of interest to the drug industry could undergo adsorption to many plastic surfaces or to any other hydrophobic surface.

II.B Direct Fluorination of Plastics

The observation that surface fluorination of plastics via treatment with fluorine gas prevents penetration of non-polar solvents was first made in the mid 1950's (Joffre, 1957). Since then, direct fluorination of plastics has been commercially exploited primarily in the auto industry to treat high-density polyethylene (HDPE) fuel tanks to make them more resistant to hydrocarbon solvent and vapor permeation, thereby reducing pollution. It has been estimated that the loss of liquids from polymeric fuel tanks can be reduced using direct fluorination by a factor of 100 (Kharitonov, 2000). A process of treating HDPE containers with mixtures of fluorine and nitrogen gas was patented in 1975 (Dixon et al., 1975; U.S. Pat. No. 3,862,284).

Direct fluorination has also been used to produce plastic membranes for the separation of gas mixtures, to enhance the receptivity of plastics to paints and ink, to decrease the friction coefficient of plastics, and to provide UV protective coatings (Kharitonov, 2000). For other recent reports concerning direct fluorination of plastics see du Toit et al., 1995; Kharitonov and Moskvin, 1998; du Toit and Sanderson, 1999; Ferraria et al., 2004; and Carstens et al., 2000.

Direct fluorination of hydrocarbons with fluorine gas proceeds through a free-radical chain reaction mechanism. In an initiation step, fluorine reacts with a hydrocarbon to produce HF and a carbon radical (R.) according to equation 1 below.

RH+F₂→R.+HF+F. (1)

This process can be accelerated by the addition of UV light or heat. In the absence of other reactive species, chain propagation occurs with each reaction site consuming a reactive particle and generating another radical according to equation 2.

R.+F₂→RF+F. (2)

In addition to causing the substitution of fluorine atoms for hydrogen atoms on alkanes, this process also saturates double and conjugated bonds with fluorine. When more energetically favorable secondary and tertiary carbon radicals may be formed, the process is exothermic due to the strong H—F bond, and can occur at room temperature.

Oxygen gas is very reactive toward radicals. In the presence of oxygen gas, carbon radicals form peroxy radicals, according to equation 3.

R.+O₂→ROO. (3)

After oxyfluorination, the process of treating surfaces simultaneously with fluorine gas and oxygen gas, the surface of polypropylene has shown evidence of the incorporation of oxygen-containing species (du Toit and Sanderson, 1999). Infared spectra of oxyfluorinated polypropylene contains signals for acid fluoride groups and carboxylic acid groups in addition to the carbon-fluoride bond stretches seen in polypropylene fluorinated in the absence of oxygen gas. Over time, peak size corresponding to the acid fluoride groups decreased, while that corresponding to the carboxylic acid group increased, suggesting hydrolysis of the acid fluoride groups, presumably due to the presence of atmospheric moisture.

Addition of a gaseous oxidant (e.g. ozone) alone, possibly in the presence of UV to accelerate the reaction, without fluorine gas, can result in a similar outcome. For example, when the functional group on the polymer is a methyl group, the reaction can be:

3RCH₃+3O₃→3RCOOH+3H₂O (4)

II.C. Acid Catalyzed Hydrolysis

Hydrolysis is a process in which a molecule is cleaved by addition of a water molecule at the site of cleavage. This reaction can be catalyzed by either an acid or a base, such as HF or NaOH. Fluorine gas in the presence of water (including water vapor in the gas, surface adsorbed water, or water absorbed through the bulk of a polymer material) will spontaneously react to form HF as follows:

2F₂+2H₂O→4HF+O₂ (5)

and

6F₂+6H₂O→12HF+2O₃ (6)

HF from these reactions can then act as a catalyst for the hydrolysis of other molecules, such as esters/polyesters, carbonates/polycarbonates, amides/polyamides, and ethers/polyethers. An example of the acid catalyzed hydrolysis reaction for a carbonate/polycarbonate is:

H₂O+ROCOOR+HF(catalyst)→ROH+HOCOOR (7)

Additionally, the oxygen or ozone produced during the formation of HF can act as an oxidant to produce more hydrophilic groups such as carboxylates from alcohols. The result is that a relatively hydrophobic polycarbonate (or other polymer) can be made more hydrophilic by addition of alcohols and carboxylates at the surface.

### III. Methods of Treating Plastic Surfaces

The presently disclosed subject matter provides a method of treating plastic surfaces to reduce their capacity for the adsorption of hydrophobic solute molecules. This method is based in part on the observation that under certain selected circumstances, exposure to fluorine gas, or fluorine gas mixed with oxygen gas, can render a plastic surface more hydrophilic. Without being bound to any one particular theory, the increased hydrophilicity of the surfaces treated by this method could be due to partial fluorination, partial oxyfluorination, partial oxidation, and/or partial hydrolysis of the surface. Thus, the method can provide plastic surfaces that include carbon-fluoride bonds, alcohols, or carboxylates, or some combination thereof. Again, without being bound to any one particular theory, hydrophobic organic solutes will be less likely to adsorb to the treated plastic surfaces, because the increased hydrophilicity of these surfaces will increase the interaction of water molecules with the surface, thereby displacing hydrophobic molecules that are bound by non-specific attractive forces, such as Van der Waals forces, that would otherwise exist between a hydrophobic molecule and a hydrophobic surface. In some embodiments, the hydrophobic solutes include known and potential drugs. In some embodiments, the hydrophobic solutes are molecules having clogP values of about 3 or greater.

In some embodiments, the method comprises exposing the plastic surface to fluorine gas and oxygen gas, fluorine gas and water vapor, or fluorine gas, oxygen gas and water vapor. In some embodiments, one or more of the fluorine gas, the oxygen gas and the water vapor are part of one or more gas mixtures. In some embodiments, one or more of the fluorine gas, the oxygen gas or the water vapor are part of a gas mixture further comprising one or more inert gases. Suitable inert gases include nitrogen and the noble gases, such as helium, argon, krypton, and neon. In some embodiments, a gas mixture will comprise about 0.5% to about 10% fluorine gas by volume. In some embodiments, a gas mixture comprises from about 1% to about 5% fluorine gas by volume. Time of exposure, percent fluorine, temperature, and UV light may be varied to control the extent of the change in surface properties.

In one embodiment, the method comprises first contacting the plastic surface with a first gas mixture containing fluorine for a first period of time to “activate” the surface; second contacting the surface for a second period of time to a second gas mixture containing oxygen gas, water vapor, or a combination of oxygen gas and water vapor. In many embodiments, the first gas mixture includes fluorine gas in a mixture with an inert gas. Suitable inert gases include nitrogen and the noble gases, such as helium, argon, krypton, and neon. In some embodiments the first gas mixture comprises about 0.5% to about 10% fluorine gas. In some embodiments, the first gas mixture comprises from about 1% to about 5% fluorine gas. In some embodiments, the first gas mixture comprises about 5% fluorine gas and about 95% of an inert gas. In some embodiments, the second gas mixture includes oxygen gas. In some embodiments, the second gas mixture includes water vapor. In some embodiments, the second gas mixture includes both water vapor and oxygen gas. In some embodiments, the second gas mixture is air.

Plastics that can be treated via this method include, but are not limited to, those made from hydrocarbon-based polymers. Such plastics generally include polyolefins, polycarbonates, polyesters, polyethers, polyamides, polyureas, polysulfones, polysiloxanes, polyurethanes, and combinations thereof including block and graft copolymers. More specifically, suitable plastics include polycarbonates, polyesters, polyamides, polyethers, high-density polyethylene, low-density polyethylene, polypropylene, polystyrene, polyurethane, polybutadiene, cyclic olefin copolymers, nylon, cellulose acetate, PPO, PPE, PET, PDMS, PMMA, and polyvinyltrimethylsilane (PVTMS).

In another embodiment, the method comprises contacting the plastic surface with a single gas mixture for a period of time. In some embodiments, the single gas mixture includes fluorine gas in a mixture with oxygen and an inert gas. In some embodiments, the single gas mixture includes fluorine gas in a mixture with oxygen, water vapor, and an inert gas. Suitable inert gases include nitrogen and the noble gases, such as helium, argon, krypton, and neon. In some embodiments the single gas mixture comprises about 0.5% to about 10% fluorine gas. In some embodiments, the single gas mixture comprises from about 1% to about 5% fluorine gas.

All of the above embodiments may be terminated by flushing the surface with a flush gas mixture. In some embodiments the flush gas mixture is air. In some embodiments the flush gas mixture comprises inert gases. Suitable inert gases include nitrogen and the noble gases, such as helium, argon, krypton, and neon. In some embodiments the flush gas mixture is followed by evacuation of the atmosphere above the surface by application of a vacuum.

All of the above embodiments can include a preliminary step of treating the surface with a pre-treatment gas mixture to standardize the starting conditions. In some embodiments the pre-treatment gas mixture is air. In some embodiments, the pretreatment gas mixture comprises inert gases. Suitable inert gases include nitrogen and the noble gases, such as helium, argon, krypton, and neon. All of the above embodiments may further include a preliminary step of placing the surface under vacuum. The step of placing the surface under vacuum may be done in lieu of treating the surface with a pre-treatment gas mixture or may be done in addition to (i.e. either directly before or directly after) treating the surface with a pre-treatment gas mixture.

In some embodiments, the method may comprise placing the surface under vacuum after exposure to the one or more gas mixtures containing fluorine gas, oxygen gas, or water vapor. In some embodiments, the method will comprise a final maturation step, wherein the plastic surface is allowed to stabilize for a period of time. In some embodiments, this maturation step will last about 24 hours. Without being bound to any particular theory, such a stabilization process could involve the hydrolysis of any surface acid fluoride groups to carboxylic acid groups due to the action of water vapor.

Thus, in summary, in some embodiments the method comprises:
(1) the surface being flushed with air for about 1 minute.
(2) the surface being placed in a vacuum for about 1 minute.
(3) the surface being flushed with a fluorine gas mixture (such as, for example, 5% fluorine:95% neon) for a period of time.
(4) the surface being flushed with air for a period of time.
(5) the surface being placed in a vacuum for about 1 minute.

As one of ordinary skill in the art will appreciate, the amount of time necessary to flush the plastic surface can depend upon the composition of the fluorine gas mixture and the temperature. In some embodiments, the temperature can be room temperature (e.g., about 20 to 25° C.) and the amount of time the plastic is flushed with the fluorine gas mixture can be between about 1 minute and about 25 minutes. In some embodiments, the amount of time the plastic is flushed with the fluorine gas mixture can be between about 1 minute and about 4 minutes. In some embodiments, the amount of time the plastic is flushed with the fluorine gas mixture can be about 2.5 minutes. Thus, as one of skill in the art will appreciate, the time period chosen is one sufficient to increase the hydrophilicity of the surface a desired degree.

The reaction between fluorine gas and plastics results in the highly corrosive side product HF. HF and unreacted F₂ from the fluorination process can be treated to produce less reactive or acidic waste products by scrubbing with caustic solutions, such as potassium hydroxide, or by treatment with dry adsorbents like alumina, limestone (CaCO₃) or activated charcoal. Thus, in some embodiments, the method will comprise an additional step of treating the waste gases (the unreacted F₂, the HF formed during reaction of the F₂ and the plastic, and any other gases that have flowed over the plastic) by passing them through a filter material to provide less reactive waste products.

Gas-based processing is particularly advantageous for treating the surfaces of miniaturized devices because these surfaces can be masked or exposed using standard techniques known in the field of microfabrication, and the gas can diffuse to all exposed surfaces with a minimum of device handling.

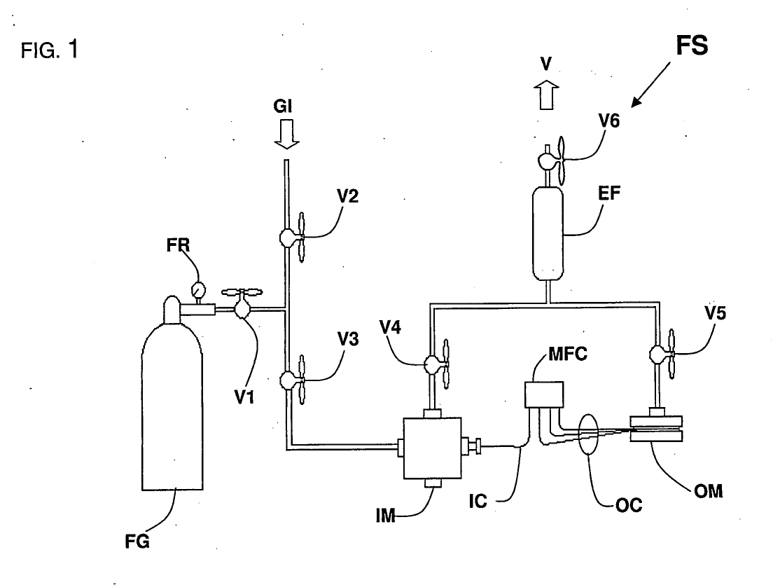

In some embodiments, the method of the presently disclosed subject matter can be carried out using an apparatus such as that depicted in FIG. 1. FIG. 1 illustrates one embodiment of an apparatus used to treat microfluidic chips, generally referred to as a fluorination system FS. Fluorination system FS comprises a fluorine gas tank FG that is attached to a system of pipes and valves that permit flushing of a microfluidic chip MFC with an inert gas, oxygen, or air through a gas input GI, with fluorine gas from fluorine gas tank FG, or with vacuum V. Fluorine gas tank FG can contain fluorine mixed with an inert gas, with a mix ranging in some embodiments from about 0.5% fluorine:99.5% inert gas to about 10% fluorine:90% inert gas. The inert gas can be nitrogen, argon, neon, helium, krypton, or another inert gas. In one embodiment, the fluorine gas tank FG contains about 1% fluorine:99% neon. Vacuum V can be at a pressure of no more than 2 p.s.i. Valves V1, V2, V3, V4, V5, and V6 are used to direct the flow of the different gases during the process.

Microfluidic chip MFC can have capillaries attached that can be used during operation of the chip to connect microfluidic chip MFC to outside fluid supplies. For example the capillaries can be input lines for various solute solutions, or they can be output lines that may be connected to waste containers. FIG. 1 shows capillaries which can be used to connect to the fluorination system, wherein one of the capillaries is used as an inlet capillary IC and the remainder are used as outlet capillaries OC. Inlet capillary IC of microfluidic chip MFC is connected to the fluorination system through an input manifold IM. Outlet capillaries OC are connected to an output manifold OM. A regulator FR can control the applied pressure of fluorine gas from fluorine gas tank FG which, in combination with resistance to flow in the system (primarily coming from the small size of the channels in the microfluidic chip MFC and in the inlet and outlet capillaries IC and OC) controls the rate of gas flow through fluorination system FS. In one embodiment, the fluorine gas mix from fluorine gas tank FG can be regulated at 30 p.s.i. by regulator FR. An exhaust gas filter EF can be located downstream of microfluidic chip MFC, and vacuum can be applied to the downstream end of exhaust gas filter EF. Exhaust gas filter EF can be activated charcoal or another material to capture unreacted fluorine gas and hydrofluoric acid. All components of fluorination system FS, including lubricating greases and rubber seals, can be made of materials resistant to the fluorine gas, such as stainless steel, brass, aluminum, and PVDF (e.g., KYNAR®; Elf Atochem North America, Inc., Philadelphia, Pa., U.S.A.).

In one embodiment of the method of the presently disclosed subject matter, the following steps are executed when treating a microfluidic chip, such as microfluidic chip MFC with an apparatus, such as, for example, fluorination system FS shown in FIG. 1:
1. Close all valves;
2. Purge fluorination system FS with nitrogen from gas input GI by opening valves V2, V3, V4, V5, and V6;
3. Close all valves;
4. Connect microfluidic chip MFC to fluorinating system FS by attaching input capillary IC to input manifold IM and output capillaries OC to output manifold OM;
5. All manifold connections not used can be plugged and sealed appropriately;
6. Open valves V2, V3, and V5, and examine all seals to capillaries IC and OC for leaks;
7. Close valve V2 and open valve V4;
8. Open valve V6 to evacuate fluorinating system FS and microfluidic chip MFC and wait about one minute;
9. Open valve V2 to fill the system with nitrogen from gas input GI and wait about one minute;
10. Close valve V4 to ensure that microfluidic chip MFC is filled with air from gas input GI and wait about one minute;
11. Close valve V2;
12. Open valve V1 and wait about 2 minutes and 40 seconds;
13. Close valve V1;
14. Immediately open valve V4 to evacuate the system and wait about 10 seconds;
15. Open valve V2 to fill the system with air through gas input GI and wait about 10 seconds;
16. Close valve V4 to force air through microfluidic chip MFC and wait about one minute;
17. Close valves V3, and V5;
18. Remove microfluidic chip MFC from fluorination system FS; and
19. Package microfluidic chip MFC in a clean container and allowed to sit at room temperature for a “maturation period” to allow the treated surface to stabilize. A typical maturation period can be about 24 hours.

A similar apparatus and process can be used to treat plastics having different shapes and configurations. For example, microfluidic chip MFC can be replaced with a chamber connected by tubes to input manifold IM and output manifold OM and other objects can be placed in the chamber to be treated. Examples of objects that can be treated by this process include pipettes micropipette tips, microtiter plates, syringes, tubes, tubing and storage vessels. Tubing also can be treated by directly connecting one end of the tubing to be treated to input manifold IM and the other end of the tubing to output manifold OM.

### IV. Plastic Articles

In some embodiments, the presently disclosed subject matter provides plastic articles comprising at least one treated plastic surface, prepared by treatment (e.g., sequential treatment or one-step treatment) with fluorine gas and oxygen gas, fluorine gas and water vapor, or fluorine gas, oxygen gas, and water vapor, according to a method disclosed herein and having a reduced capacity for the adsorption of hydrophobic solute molecules as compared to the plastic surface prior to treatment. In some embodiments, the treated surfaces have a reduced capacity for the adsorption of potential or known drug molecules. Such molecules can include synthetic molecules, including those prepared via a combinatorial synthesis technique, or molecules isolated through the extraction of a biologically derived material, such as a plant- or animal-derived tissue or fluid. The molecules may be potential or known enzymatic inhibitors or the agonists, antagonists, partial agonists, or partial antagonists of a biologically relevant receptor. The potential or known drug molecule can be a substrate of an enzyme. For example, some drugs must undergo an enzymatic reaction in vivo to achieve an active form. In some embodiments, the drug molecules will have a clogP of about 3 or above.

The hydrophobic solute molecule is not limited to drug molecules, however. In some embodiments, the solute will be a reporter molecule, such as a tracer dye. In some embodiments, the solute can be an environmental toxin. The solute may be of use in biochemical research, for example, in determining the mechanism of an enzyme. Thus, the solute can be a non-drug enzyme inhibitor or substrate.

In some embodiments, the solute molecule is a solute of an aqueous solution. In some embodiments, the solute molecule is a solute of a solution containing one or more organic solvents. For instance, in some embodiments, the hydrophobic solute molecules may not dissolve readily in water or in an aqueous buffer without first being dissolved in a water miscible organic solvent, such as, for example, dimethyl sulfoxide (DMSO), dimethylformamide (DMF), acetonitrile, or an alcohol. The solution containing the dissolved molecules can then be further diluted with water or an aqueous buffer. In some embodiments, the solute molecules can be dissolved in a solution containing only organic solvents.

Thus, in some embodiments, the presently disclosed subject matter provides improved plastic articles for use as pharmaceutical and biochemical research devices, and environmental testing devices. Such articles include sample transfer tools, such as pipettes and micropipette tips, syringes, and plastic tubing. Such articles also include sample storage vessels, such as test tubes, microtubes, vials, bottles, and flasks. The articles can include the housing of tools used in a sample processing or separation step, such as a centrifuge tubes, chromatography columns, or solid-phase extraction assemblies. Such articles also include the tools used for biochemical and/or automated experiments such as microwells or microtiter plates.

In general, the one or more treated surface of the plastic articles of the presently disclosed subject matter will be the surface or surfaces that come into contact with the solute-containing solution. Thus, for example, at a minimum, the interior surface of the wells of the microtiter plates of the presently disclosed subject matter will be treated surfaces that have reduced solute adsorption. However, it may also be desirable, based upon the end use of the device or upon the manner in which it was prepared, that all of the surfaces of the device will be treated. For example, one might prepare micropipette tips with treated surfaces more easily by placing a number of tips in a container and passing a fluorine gas mixture and then air through the entire container. All surfaces, both interior and exterior, of micropipette tips prepared in this fashion would be treated to have reduced adsorption of hydrophobic solutes.

As will be apparent to one of ordinary skill in the art, and in light of the disclosure above, the treated plastic article of the presently disclosed subject matter can be especially advantageous when used with solutions containing very low concentrations of solutes of interest, such as when handling or testing very potent drug substances or when looking for very low levels of contaminants in environmental samples. The treated plastic articles can also be of particular use when determining concentration-dependent variables, such as the use of microtiter plates for determining binding constants, or for other concentration-dependent uses, such as when using a vial to dispense multiple aliquots of a drug-containing solution.

### V. Microfluidic Chips and Systems

In recent years, microfluidic systems have proven useful in a wide variety of applications; non-limiting examples of which include enzyme kinetics, efficacy and toxicity studies for drug development, cell-based assays, flow cytometry, gradient elution for mass spectrometry, and clinical diagnostics for neo-natal care (e.g., blood enzyme diagnostics with microliter samples). Specific drug potency measurements that can be analyzed include IC₅₀ and EC₅₀. IC₅₀ and EC₅₀ stand for the concentration of a compound achieving 50% of the maximal excitatory (EC₅₀) or inhibitory (IC₅₀) activity of that compound. Drug toxicity studies can include P450 assays or S9 fraction assays. Specific enzymological variable and measurements that can be analyzed and prepared, include, but are not limited to:

(1) basic steady-state kinetic constants, such as Michaelis constants for substrates (Kₘ), maximum velocity (Vₘₐₓ), and the resultant specificity constant (Vₘₐₓ/Kₘ or k_{cat}/Kₘ);

(2) binding constants for ligands (K_{d}) and capacity of receptor binding (Bₘₐₓ);

(3) kinetic mechanism of a bi- or multi-substrate enzyme reaction;

(4) effect of buffer components, such as salts, metals and any inorganic/organic solvents and solutes on enzyme activity and receptor binding;

(5) kinetic isotope effect on enzyme catalyzed reactions;

(6) effect of pH on enzyme catalysis and binding;

(7) dose-response of inhibitor or activator on enzyme or receptor activity (IC₅₀ and EC₅₀ value);

(8) analysis of mechanism of inhibition of an enzyme catalyzed reaction and associated inhibition constants (slope inhibition constant (Kᵢₛ) and intercept inhibition constant (Kᵢᵢ));

(9) equilibrium binding experiments to determine binding constants (K_{d});

(10) determination of binding stoichiometry via a continuous variation method; and

(11) determination of an interaction factor (α) between multiple inhibitors, ligands, or ligands and inhibitors by a method of continuous variation.

Microfluidic systems for use in analyzing miniaturized biochemical reactions have many advantages over conventional devices, such as microtiter plates. These advantages include: (1) 1000-fold reduction in the amount of reagent needed for a given assay or experiment; (2) elimination of the need for disposable assay plates; (3) fast, serial processing of independent reactions; (4) data readout in real-time; (5) improved data quality; (6) more fully integrated software and hardware, permitting more extensive automation of instrument function, 24/7 operation, automatic quality control and repeat of failed experiments or bad gradients, automatic configuration of new experimental conditions, and automatic testing of multiple hypotheses; (7) fewer moving parts and consequently greater robustness and reliability; and (8) simpler human-instrument interface. As the description proceeds, other advantages may be recognized by persons skilled in the art.

Further, microfluidic systems have an advantage over more conventional methods of determining concentration critical data such as ligand-receptor binding constants, drug potency measurements and enzyme kinetics in that, rather than relying on a series of experiments to observe a concentration gradient based upon several discrete concentrations along that gradient, microfluidic devices can be set up such that concentrations of various reaction components may be varied with continuous concentration gradients. Such microfluidic devices (which may also be referred to herein as sample processing apparatuses) have been described in a co-pending, commonly assigned U.S. Provisional Application entitled MICROFLUIDIC APPARATUS AND METHOD FOR SAMPLE PREPARATION AND ANALYSIS, U.S. Provisional Application No. 60/707,373 (Attorney Docket No. 447/99/2/1). The use of such devices for characterizing biological molecule modulators is described in greater detail in a co-pending, commonly assigned U.S. Provisional Application entitled MICROFLUIDIC METHODS AND APPARATUSES FOR FLUID MIXING AND VALVING, U.S. Provisional Application No. 60/707,329 (Attorney Docket No. 447/99/2/4) and U.S. Provisional Application entitled METHODS FOR CHARACTERIZING BIOLOGICAL MOLECULE MODULATORS, U.S. Provisional Application No. 60/707,328 (Attorney Docket No. 447/99/5/1).

The presently disclosed subject matter provides microfluidic chips and systems comprising microfluidic channels having treated plastic surfaces, the treatment comprising contacting the surface with fluorine gas and oxygen gas and/or water vapor, as disclosed in detail herein above. Such channels have a reduced capacity for the adsorption of hydrophobic solutes from solutions flowing through the chips and systems. As described above, due to the large surface to volume ratios of microfluidic channels, adsorption of solute molecules can be a problem of microfluidic devices when accurate control or measurement of solute concentration is a goal. In particular, the microfluidic chips and systems of the presently disclosed subject matter facilitate accurate processing of solutions containing low concentrations of hydrophobic molecules, including many drugs and other biologically relevant molecules. Therefore, microfluidic systems of the presently disclosed subject matter will provide advantages in analyzing miniaturized biochemical reactions.

To provide internal channels, microfluidic chips of the presently disclosed subject matter can, in general, comprise two body portions, such as plates or layers, with one body portion serving as a substrate or base on which features such as channels are formed and the other body portion serving as a cover. The two body portions can be bonded together by any means appropriate for the materials chosen for the body portions. Non-limiting examples of bonding techniques include lamination, gluing, thermal bonding, laser welding, and ultrasonic welding. Non-limiting examples of materials used for the body portions include various structurally stable polymers (plastics) such as polystyrenes, polypropylenes, polycarbonates, DPMS, polyurethanes, PET, and cyclic olefin copolymers. The body portions can be constructed from the same or different materials. To enable optics-based data encoding of analytes processed by microfluidic chip MFC, one or both body portions can be optically transmissive or transparent. Non-limiting examples of optically transmissive plastics include cyclic olefin copolymers and polycarbonates. The channels can be formed by any suitable micro-fabricating techniques appropriate for the materials used, such as the various embossing methods, laser ablation, and injection molding. The original molds for the microfluidic chips may be formed by any common microfabrication technique such as photolithography, wet chemical etching, micromachining, and the like. Polymer microfabrication methods have recently been reviewed (Becker and Gärtner, 2000). In some embodiments, the chips may be treated using fluorine gas and air as the last step of the fabrication process (i.e., after bonding of the two body parts). In some embodiments, the chip is treated in a fluorination apparatus such as that shown in FIG. 1, according to the method described hereinabove.

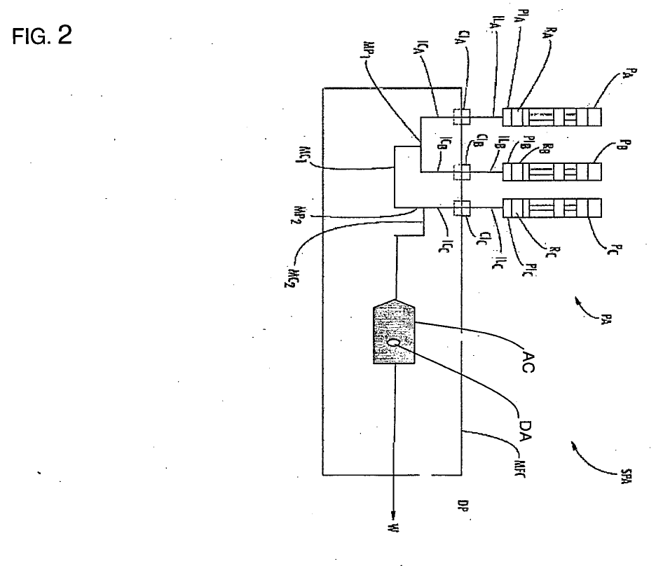

In many embodiments, for example in that shown in FIG. 2, the microfluidic chip is part of a system or sample processing apparatus that includes components exterior to the chip itself. According to one embodiment, one or more linear displacement pump is provided for producing low, non-pulsatile liquid flow rates for introducing a reagent solution to one or more of the microfluidic channels. Such a pump comprises a servo motor drive, a lead screw, a stage, a barrel, and a plunger. The servo motor drive has a gear reduction suitable for producing liquid flow rates grading from between about 0 nl/min and 500 nl/min, with a precision as low as approximately 0.1 nl/min. The lead screw is coupled to the motor drive for rotatable actuation thereby, and has a thread pitch suitable for producing liquid flow rates grading from between about 0 nl/min and 500 nl/min, with a precision as low as approximately 0.1 nl/min. The stage engages the lead screw and is linearly translatable thereby. The barrel is adapted for containing a liquid; and has an internal volume ranging from approximately 5 to approximately 500 μl. The plunger extends into the barrel and is coupled to the stage for translation therewith. In some embodiments for which a plurality of pumps are provided (e.g., pumps P_{A}-P_{C} of FIG. 2), the respective operations of the plurality of pumps and thus the volumetric flow rates produced thereby are individually controllable according to individual, pre-programmable fluid velocity profiles. The use of pumps driven by servo motors can be advantageous in that smooth, truly continuous (i.e., non-pulsatile and non-discrete) flows can be processed in a stable manner. In some embodiments, pumps are capable of producing flow rates permitting flow grading between about 0 and 500 nl/min, with a precision of 0.1 nl/min in a stable, controllable manner. Optionally, pumps can produce flow rates permitting flow grading from 0 to as little as 5 nl/min. Moreover, the operation of each servo motor (e.g., the angular velocity of its rotor) can be continuously varied in direct proportion to the magnitude of the electrical control signal applied thereto. In this manner, the ratio of two or more converging streams of reagents (e.g, reagents R_{A}-R_{C} in FIG. 2) can be continuously varied over time to produce continuous concentration gradients in microfluidic chip MFC. Thus, the number of discrete measurements that can be taken from the resulting concentration gradient is limited only by the sampling rate of the measurement system employed and the noise in the concentration gradient. Additional details and features of suitable pumps and pump assemblies are disclosed in co-pending, commonly assigned U.S. Provisional Application entitled APPARATUS AND METHOD FOR HANDLING FLUIDS AT NANO-SCALE RATES, U.S. Provisional Application No. 60/707,421 (Attorney Docket No. 447/99/2/2).

Prior to the use of a device of the presently disclosed subject matter, any suitable method can be performed to purge the channels of the microfluidic chip to remove any contaminants, as well as bubbles or any other compressible fluids affecting flow rates and subsequent concentration gradients. For instance, referring now to sample processing apparatus SPA shown in FIG. 2, prior to loading reagents R_{A}-R_{C} into pump assembly PA, pump assembly PA can be used to run a solvent through microfluidic chip MFC. Any configuration and calibration of the equipment used for detection/measurement can also be performed at this point, including the selection and/or alignment of optical equipment such as the optics described hereinbelow.

Referring again to FIG. 2, sample processing apparatus SPA presents an embodiment of a microfluidic chip-based apparatus used to measure the IC₅₀ of enzyme inhibitors. Generally, sample processing apparatus SPA can be utilized for precisely generating and mixing continuous concentration gradients of reagents in the nl/min to μl/min range, particularly for initiating a biological response or biochemical reaction from which results can be read after a set period of time. Sample processing apparatus SPA generally comprises a reagent introduction device advantageously provided in the form of a pump assembly, generally designated PA, and a microfluidic chip MFC. Pump assembly PA comprises one or more servo motor-driven, linear displacement pumps such as syringe pumps or the like. For mixing two or more reagents, pump assembly PA comprises at least two or more pumps. In the illustrated embodiment in which three reagents can be processed (e.g., reagent R_{A}, R_{B}, and R_{C}), sample processing apparatus SPA includes a first pump P_{A}, a second pump P_{B}, and a third pump P_{C}. More than three pumps can be employed similarly with different topologies of channels on microfluidic chip MFC being possible. Sample processing apparatus SPA is configured such that pumps P_{A}, P_{B} and P_{C} are disposed off-chip but inject their respective reagents R_{A}, R_{B} and R_{C} directly into microfluidic chip MFC via separate input lines IL_{A}, IL_{B} and IL_{C} such as fused silica capillaries, polyetheretherkeonte (PEEK) tubing, or the like. In some embodiments, the input lines are composed of plastic tubing, the interior surface of which has been treated to reduce surface adsorption of solutes. In some embodiments, the outside diameter of input lines IL_{A}, IL_{B} and IL_{C} can range from approximately 50-650 μm. In some embodiments, each pump P_{A}, P_{B} and P_{C} interfaces with its corresponding input line IL_{A}, IL_{B} and IL_{C} through a pump interconnect PI_{A}, PI_{B} and PI_{C} designed for minimizing dead volume and bubble formation, and wherein the parts that are prone to degradation or wear are replaceable parts.

In a typical IC₅₀ experiment, the reagent streams are combined to create a final reaction mix in the mixing channel MC2. This reaction mix is then advanced by the combined flows of pumps P_{A}, P_{B}, and P_{C} into an analysis channel. In some embodiments, the analysis channel is an analysis channel AC, as shown in FIGS. 2-4B, which will be disclosed in further detail herein below. As the reaction mix flows through-analysis channel AC, the reaction proceeds and a reaction product is measured at a detection area DA. Flow continues through microfluidic chip MFC to a channel leading to an off-chip waste receptacle W. Typically, the flow rates of pumps P_{A}, P_{B} and P_{C} are controlled such that as one pump decreases its flow rate, another pump increases its flow rate, such that the combined flow of the three pumps is held constant. Pump P_{A} can hold buffer, the inhibitory compound under test (the “inhibitor”), and a tracer dye that is used to report the concentration of the inhibitor. Pump P_{B} can contain buffer only. The reagent streams from pumps P_{A} and P_{B} are run as a complementary pair, with their combined flow rates equaling, for example, 15 nl/min. Thus, the reagent streams from these two pumps can combine at mixing point MP1. Pump P_{A} can start at a flow rate of 15 nl/min and pump P_{B} can start at a flow rate of 0 nl/min. After 2-3 minutes, the flow rate of pump P_{A} can be decreased linearly with time to 0 nl/min, and the flow rate of pump P_{B} can be increased linearly to 15 nl/min. The flow rate can then be held at this flow rate for another 2-3 minutes. Thus, the combined flows of pumps P_{A} and P_{B} can create a concentration gradient of the inhibitor and associated tracer dye. The combined flows of pumps P_{A} and P_{B} can flow from mix point MP1 to mix point MP2 where they combine with the flow of pump P_{C}. The reagent stream from pump P_{C} can contain the enzyme or other receptor against which the inhibitor is being tested. The flow rate of pump P_{C} can be constant at, for example, 15 nl/min such that the combined flow rates of pumps P_{A}, P_{B} and P_{C} can be constant at 30 nl/min. Thus, the concentration of the enzyme can be held constant, and the concentration of the inhibitor can vary in the reagent stream.

The presently disclosed subject matter provides for, in some embodiments, the use of large channel diameters in regions of the microfluidic chip most affected by adsorption of reaction components, that is, in regions where concentration measurements are taken. An analytical chamber with large channel diameters is sometimes referred to herein as an analysis channel. Such channels work upon the principal that, in general terms, the effects of adsorption on concentration measurements can be minimized by reducing the ratio of channel surface area to fluid volume (S/V), thereby increasing diffusion distances. This can serve to further enhance the lowered adsorption characteristics of microfluidic devices containing treated plastic surfaces. Thus, in some embodiments of the presently disclosed subject matter, microfluidic chips are provided comprising an analysis channel with an enlarged cross-sectional area and a reduced surface area to volume ratio and further comprising channels having surfaces treated with fluorine gas which exhibit properties of decreased adsorption of solute molecules in comparison to untreated surfaces.

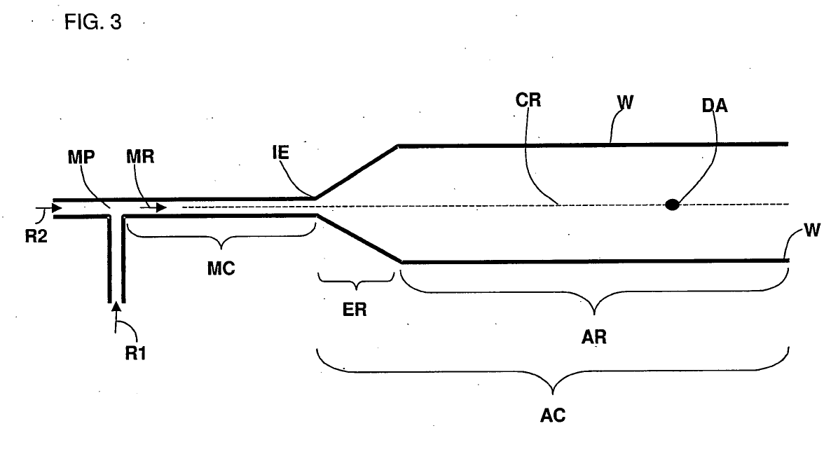

Referring now to FIG. 3, an embodiment of an analysis channel of the presently disclosed subject matter is illustrated in a top view. FIG. 3 shows the direction of flow by arrows R1 and R2 of two fluid reagent streams, which can combine at a merge region or mixing point MP. After combining into a merged fluid stream, the reagents within the stream can flow in a direction indicated by arrow MR down a mixing channel MC that can be narrow to permit rapid diffusional mixing of the reagent streams, thereby creating a merged fluid reagent stream. The fluid stream of reagents can then pass into an analysis channel AC, at an inlet or inlet end IE that can have a channel diameter and a cross-sectional area equivalent to that of mixing channel MC. The merged fluid stream can then flow through an expansion region ER that can have a cross-sectional area that can gradually increase and where the surface area to volume ratio can thereby gradually decrease. The merged fluid stream can then continue into an analysis region AR of analysis channel AC with an enlarged cross-sectional area and a reduced surface area to volume ratio. A reaction can be initiated by mixing of the reagent streams at mixing point MP. However, due to continuity of flow, the flow velocity slows dramatically in analysis region AR of analysis channel AC, and the majority of transit time between mixing point MP and a detection area DA is spent in the larger diameter analysis region AR. Measurements can be made inside this channel, such as with confocal optics, to achieve measurements at detection area DA, which can be located at a center axis or central analysis region CR of analysis region AR of analysis channel AC. Center analysis region CR can be a region equidistant from any channel wall W of analysis channel AC. Thus, the fluid at center analysis region CR of detection area DA can be effectively “insulated” from adsorption at channel walls W. That is, the amount of any reagents removed at channel wall W can be too small, due to the greatly decreased surface area, and the diffusion distance to channel wall W can be too long, due to the greatly increased diffusion distance from center analysis region CR to channel wall W, to greatly affect the concentration at centerline CL. The confocal optics, for example, can reject signal from nearer channel wall W of analysis region AR, permitting measurements to be made at center analysis region CR where the concentration is least affected by adsorption at channel wall W.

A consequence of increasing analysis channel AC cross-section by increasing channel diameter is that the ratio of channel surface area to fluid volume (S/V) within the channel is decreased, relative to a narrower channel. For example, to measure a reaction 3 minutes after mixing, with a volumetric flow rate of 30 nl/min, the reaction can be measured at a point in the channel such that a microfluidic channel section spanning from mixing point MP to detection area DA encloses 90 nl. For an analysis channel with a square cross-section and a diameter of 25 μm, this point is about 144 mm downstream from mix point MP. This channel has a surface area of 1.44×10⁻⁵ square meters, yielding a surface to volume ratio SN equal to 1.6×10⁵ m⁻¹. For a channel with a diameter of 250 μm, the measurement is made 1.44 mm downstream from mix point MP. This wider channel has a surface area of 1.44×10⁻⁶ square meters, yielding a S/V equal to 1.6×10⁴ m⁻¹, which is 1/10^{th} the S/V of the narrower channel. This alone can decrease ten-fold the removal of compound per unit volume by adsorption.

This geometry change can also decrease the radial diffusive flux of compound. Flow in these small channels is at low Reynolds number, so diffusion from a point in the fluid is the only mechanism by which compound concentration changes radially in a microfluidic channel. Increasing the radius of the channel, thereby decreasing the radial diffusive flux, therefore, means that the concentration of compound at center analysis region CR of analysis region AR can be less affected by adsorption than in the smaller upstream channels.

Thus, increasing the cross-sectional area of analysis region AR of analysis channel AC can both decrease the amount of adsorption at the wall per unit volume and decrease the rate of flux of compound from center analysis region CR to any of channel walls W. Both together mean that the concentration at center analysis region CR can decrease more slowly due to adsorption of compound.

Further, in some embodiments, the surface area of all channels exposed to compounds, not just analysis channel AC, can preferably be kept minimal, especially those channels through which concentration gradients flow. This can be accomplished by making channels as short as practicable. Additionally, when the volume contained by a channel must be defined (e.g. where the channel must contain a volume of 50 nl), larger diameters/shorter lengths can be used wherever possible to reduce S/V.

With this in mind, another benefit of increasing analysis channel AC cross-section by increasing channel diameter is that the length of the channel down which the fluid flows can be reduced. In the example given earlier, a channel with 25 μm diameter needed to be 144 mm long to enclose 90 nl whereas the channel with 250 μm diameter needed to be only 1.44 mm long. This shorter channel can be much easier to fabricate and has a much smaller footprint on a microfluidic chip. A similar approach can be used in the design of injection loops on the microfluidic chip.

An injection loop can be used when the analysis must occur inside a closed system, such as a system of tubing or a microfluidic chip. An injection loop works similar to a segment of pipe that can be removed from a piping system and then reconnected. The injection loop is removed, filled with the liquid, and then reconnected. When flow through the pipe resumes, the liquid in the injection loop then is flushed into the analytical system. Injection loops are commonly used for applications such as liquid chromatography. Injection loops are available from a variety of manufacturers including Valco Instruments Co. Inc. of Houston, Tex. In some embodiments, the injection loop can be used with a microfluidic chip either separate from the chip or contained in part or entirely on the chip. Injection loops are described in further detail in co-pending, commonly assigned U.S. Provisional Application entitled MICROFLUIDIC METHODS AND APPARATUSES FOR FLUID MIXING AND VALVING, U.S. Provisional Application No. 60/707,329 (Attorney Docket No. 447/99/2/4), herein incorporated by reference in its entirety. Injection loops with larger diameters and shorter lengths for enclosing a given volume will have smaller surface area to volume (S/V) ratios. Additionally, incorporation of injection loops onto the microfluidic chip insures the surfaces of the microfluidic channels comprising the injection loop are treated by the methods disclosed above. Still another benefit of increasing analysis channel AC cross-section is that it will behave like an expansion channel, which filters noise out of chemical concentration gradients, as disclosed in co-pending, commonly assigned U.S. Provisional Application entitled MICROFLUIDIC SYSTEMS, DEVICES AND METHODS FOR REDUCING NOISE GENERATED BY MECHANICAL INSTABILITIES, U.S. Provisional Application No. 60/707,245 (Attorney Docket No. 447/99/3/2), herein incorporated by reference in its entirety. The result is that signal to noise is larger in an analysis channel AC with larger cross-section.

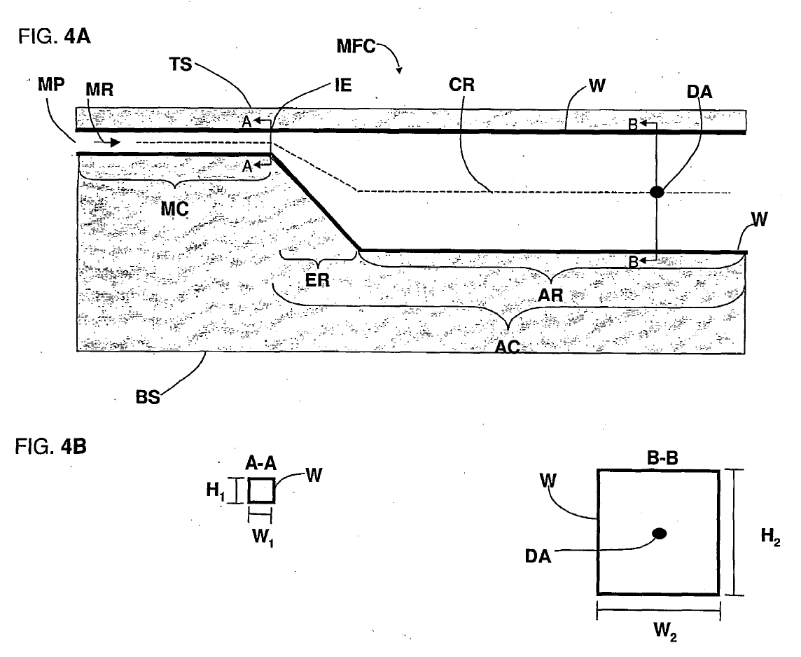

FIG. 4A presents a cross-sectional side view of a portion of a microfluidic chip MFC comprising mixing channel MC and analysis channel AC depicted in FIG. 3. Microfluidic chip MFC shown in FIG. 4A can be constructed by machining channels into a bottom substrate BS and enclosing channels by bonding a top substrate TS to bottom substrate BS or otherwise forming channels within microfluidic chip MC with bottom substrate BS and top substrate TS being integral. In FIG. 4A, only the flow of merged reagent fluid stream having a flow direction indicated by arrow MR after mixing point MP is shown. Flow in a microfluidic channel can be at low Reynolds number, so the streamline of fluid that flows along center analysis region CR of the narrower mixing channel MC can travel at the mid-depth along entire mixing channel MC, becoming center analysis region CR of analysis region AR of analysis channel AC. Detection area DA can reside along center analysis region CR at a point sufficiently far downstream of mixing channel MC to permit the reaction to proceed to a desired degree.

Analysis channel AC can approximate a circular cross-section as closely as possible to produce the smallest ratio of surface area to volume, and also to produce the largest diffusion distance from centerline center analysis region CR to a channel wall W. However, microfluidic channels may not be circular in cross-section due to preferred manufacturing techniques. Rather, they can be more square in cross-section, with the exact shape depending on the technique used to form the channels. For such channels, a cross-section of analysis channel AC, particularly within analysis region AR, can have an aspect ratio as close to one as possible or, more precisely stated, the distance from center analysis region CR to channel wall W can be as nearly constant in all radial directions as possible.

FIG. 4B shows two different cross-sectional views along analysis channel AC as viewed along cutlines A-A and B-B. Both cross-sectional views illustrate an aspect ratio approximating one. That is, for cross-section A-A, height H₁ of mixing channel MC is approximately equal to width W₁ of mixing channel MC, such that H₁/W₁ approximately equals one. Comparably, for cross-section B-B, height H₂ of mixing channel MC is approximately equal to width W₂ of mixing channel MC, such that H₂/W₂ approximately equals one.

FIG. 4B further shows that the cross-sectional area (H₂×W₂) of analysis region AR at cutline B-B, which is located at detection area DA of analysis region AR, is significantly larger than the cross-sectional area (H₁×W₁) of input end IE at cutline A-A. In some embodiments of the presently disclosed subject matter, the cross-sectional area at detection area DA can be at least twice the value of the cross-sectional area value at input end IE and further upstream, such as in mixing channel MC. Further, in some embodiments, the cross-sectional area at detection area DA can be between about two times and about five hundred times the value of the cross-sectional area value at input end IE. As shown in cutline B-B of FIG. 4B, detection area DA can be positioned along center analysis region CR approximately equidistant from each of walls W to provide maximal distance from walls W, and thereby minimize effects of molecule adsorption to walls W. It is clear from FIG. 4B that the larger cross-sectional area at cutline B-B can provide both greater distance from walls W and smaller SN than the smaller cross-sectional area at cutline A-A, both of which can reduce adsorption effects on data analysis, as discussed herein. Although detection area DA is shown in the figures as a circle having a distinct diameter, the depiction in the drawings is not intended as a limitation to the size, shape, and/or location of detection area DA within the enlarged cross-sectional area of analysis region AR. Rather, detection area DA can be as large as necessary and shaped as necessary (e.g. circular, elongated oval or rectangle, etc.) to acquire the desired data, while minimizing size as much as possible to avoid deleterious adsorption effects on the data. Determination of the optimal balance of size, shape and location while minimizing adsorption effects is within the capabilities of one of ordinary skill in the art without requiring undue experimentation.

Additional details and features of analysis channels with advantageous geometries are disclosed in co-pending, commonly assigned U.S. Provisional Application entitled METHODS AND APPARATUSES FOR REDUCING EFFECTS OF MOLECULE ADSORPTION WITHIN MICROFLUIDIC CHANNELS, U.S. Provisional Application No. 60/707,366 (Attorney Docket No. 447/99/8), herein incorporated by reference in its entirety.

Many embodiments of the sample processing apparatus of the presently disclosed subject matter will comprise one or more useful components for analytical testing and data acquisition according to spectroscopic, spectrographic, spectrometric, or spectrophotometric techniques, and particularly UV or visible molecular absorption spectroscopy and molecular luminescence spectrometry (including fluorescence, phosphorescence, and chemiluminescence). Thus, in addition to a microfluidic chip, a sample processing apparatus may include an analytical signal measurement device. The analytical signal measurement device may include an electromagnetic signal source and an optical signal receiver. In some embodiments, as will be described further herein below, the optical signal receiver can measure fluorescence or photons and the electromagnetic signal source can be a laser, a lamp, or a group of lamps for multi-wavelength excitation. In some embodiments, the components of the analytical signal measurement device can be arrayed such that the signal receiver is measuring a signal in the sample fluid stream at a detection area of the microfluidic chip. Thus, a detection area can be thought of as a virtual sample cell or cuvette. Additionally, the sample processing apparatus may include a chip holder, which can be provided as a platform for mounting and positioning the microfluidic chip, with repeatable precision if desired, especially one that is positionally adjustable to allow the user to view selected regions of the microfluidic chip and/or align the microfluidic chip (e.g., one or more of the detection areas thereof) with associated optics. Further, the sample processing apparatus may include a thermal control unit or circuitry that can regulate the temperature of part of the sample processing apparatus, such as, for example, one or more of the pump assemblies or the microfluidic chip.

In some embodiments, the electromagnetic signal source of an apparatus of the presently disclosed subject matter will comprise an excitation source. Generally, the excitation source can be any suitable continuum or line source or combination of sources for providing a continuous or pulsed input of initial electromagnetic energy to a detection area of a microfluidic chip. Non-limiting examples include lasers, such as visible light lasers including green HeNe lasers, red diode lasers, and frequency-doubled Nd:YAG lasers or diode pumped solid state (DPSS) lasers (532 nm); hollow cathode lamps; deuterium, helium, xenon, mercury and argon arc lamps; xenon flash lamps; quartz halogen filament lamps; and tungsten filament lamps. Broad wavelength emitting light sources can include a wavelength selector as appropriate for the analytical technique being implemented, which can comprise one or more filters or monochromators that isolate a restricted region of the electromagnetic spectrum. Upon irradiation of the sample at a detection area, a responsive analytical signal having an attenuated or modulated energy is emitted and received by the optical signal receiver.

Any suitable light-guiding technology can be used to direct the electromagnetic energy from the excitation source, through the microfluidic chip, and to the remaining components of the measurement instrumentation. In some embodiments, optical fibers are employed. The interfacing of optical fibers with microfluidic chips according to advantageous embodiments is disclosed in a co-pending, commonly owned U.S. Provisional Application entitled MICROFLUIDIC CHIP APPARATUSES, SYSTEMS, AND METHODS HAVING FLUIDIC AND FIBER OPTIC INTERCONNECTIONS, U.S. Provisional Application No. 60/707,246 (Attorney Docket No. 447/99/4/2), the contents of which are incorporated herein in its entirety. In some embodiments, a miniaturized dip probe can be employed at a detection area, in which both the optical sending and returning fibers enter the same side of the microfluidic chip and a reflective element routes the optical signal down the sending fiber back through the microfluidic channel to the returning fiber. Similarly a single fiber can be used both to introduce the light and to collect the optical signal and return it to a detector. For example, the excitation light for a fluorophore can be introduced into the microfluidic chip by an optical fiber, and the fluorescent light emitted by the sample in the microfluidic chip can be collected by that same fiber and transmitted to a photodetector, with appropriate wavelength selectors permitting rejection of excitation light at the photodetector.

The optical signal receiver of the presently disclosed subject matter may include one or more wavelength selectors, a photoelectric transducer and a signal processing and readout device. The wavelength selectors of the optical signal receiver may comprise one or more filters or monochromators that isolate a restricted region of the electromagnetic spectrum and provide a filtered signal to the optical signal receiver. The optical signal receiver may include any appropriate photoelectric transducer that converts the radiant energy of a filtered analytical signal into an electrical signal suitable for use by a signal processing and readout device. Non-limiting examples of photoelectric transducers include photocells, photomultiplier tubes (PMTs), avalanche photodiodes (APDs), photodiode arrays (PDAs), and charge-coupled devices (CCDs). In particular, for fluorescence measurements, a PMT or APD may be operated in a photon counting mode to increase sensitivity or yield improved signal-to-noise ratios. Advantageously, the photoelectric transducer may be enclosed in an insulated and opaque box to guard against thermal fluctuations in the ambient environment and keep out light.

The signal processing and readout device may perform a number of different functions as necessary to condition the electrical signal for display in a human-readable form, such as amplification (i.e., multiplication of the signal by a constant greater than unity), phase shifting, logarithmic amplification, ratioing, attenuation (i.e., multiplication of the signal by a constant smaller than unity), integration, differentiation, addition, subtraction, exponential increase, conversion to AC, rectification to DC, comparison of the transduced signal with one from a standard source, and/or transformation of the electrical signal from a current to a voltage (or the converse of this operation). In addition, the signal processing and readout device may perform any suitable readout function for displaying the transduced and processed signal, and thus can include a moving-coil meter, a strip-chart recorder, a digital display unit such as a digital voltmeter or CRT terminal, a printer, or a similarly related device. Finally, the signal processing and readout device may control one or more other components of the sample processing apparatus as necessary to automate the mixing, sampling/measurement, and/or temperature regulation processes of the methods disclosed herein. For instance, the signal processing and readout device can be placed in communication with an excitation source, one or more pump assemblies, pumps, or a thermal control unit via suitable electrical lines to control and synchronize their respective operations.

In some embodiments of the presently disclosed subject matter, more than one detection area can be defined so as to enable multi-point measurements. This permits, for example, the measurement of a reaction product at multiple points along the analysis channel and hence analysis of time-dependent phenomena or automatic localization of the optimum measurement point (e.g., finding a point yielding a sufficient yet not saturating analytical signal).

Many embodiments disclosed herein comprise hardware and/or software components for controlling liquid flows in microfluidic devices and measuring the progress of miniaturized biochemical reactions occurring in such microfluidic devices. As appreciated by persons skilled in the art, the signal processing, readout, and system control functions can be implemented in individual devices or integrated into a single device, and can be implemented using hardware (e.g., a PC computer), firmware (e.g., application-specific chips), software, or combinations thereof. The computer can be a general-purpose computer that includes a memory for storing computer program instructions for carrying out processing and control operations. The computer can also include a disk drive, a compact disk drive, or other suitable component for reading instructions contained on a computer-readable medium for carrying out such operations. In addition to output peripherals such as a display and a printer, the computer can contain input peripherals such as a mouse, keyboard, barcode scanner, light pen, or other suitable component known to persons skilled in the art for enabling a user to input information into the computer.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### Example 1

### Dependence of Surface Hydrophilicity on Fluorination Time

A flat piece of polycarbonate (formed from a CALIBRE™ 200 series resin, Dow Chemicals, Wilmington, Del., USA) was treated according to the method of the following steps:
(1) the surface was flushed with air for about 1 minute;
(2) the surface was placed in a vacuum for about 1 minute;
(3) the surface was flushed with a fluorine gas mixture containing 5% fluorine and 95% neon for a period of time;
(4) the surface was flushed with air for about 1 minute; and
(5) the surface was placed in a vacuum for about 1 minute.

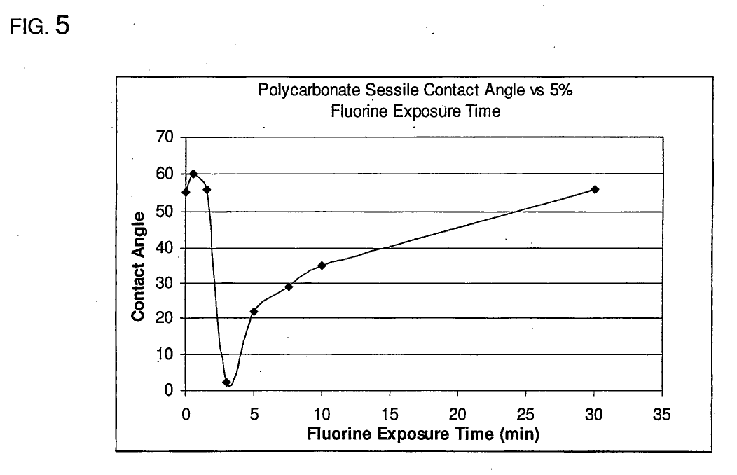

FIG. 5 shows the contact angle between water and the treated polycarbonate for polycarbonate samples treated with the fluorine gas mixture for different periods of time. As can be seen in FIG. 5 at time 0, the contact angle of untreated polycarbonate is about 55, indicating that it is hydrophobic, but not as hydrophobic as, for example, TEFLON®. After approximately 2½ minutes, the contact angle decreased to nearly zero, indicating the surface has become highly hydrophilic. The contact angle then increased with longer treatments, a trend that has been reported for the direct fluorination of polypropylene and polyethylene. See du Toit et al., 1995; and du Toit and Sanderson, 1999.

### Example 2

### IC₅₀ Determination Using a Non-Treated SPA

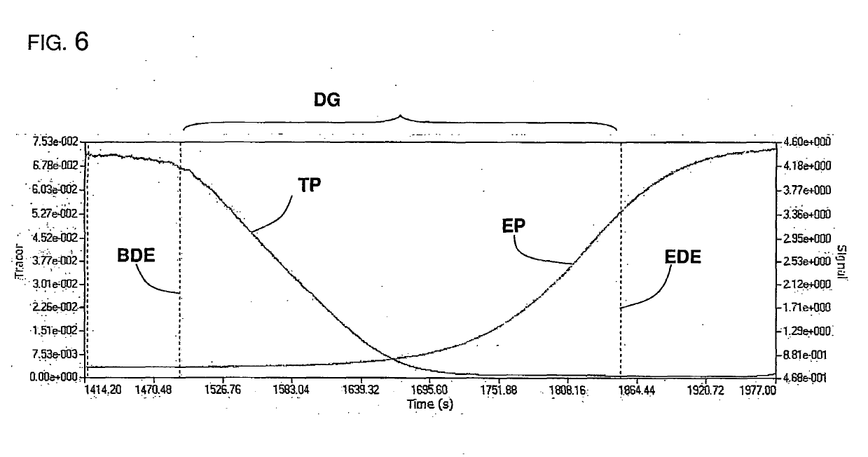

FIG. 6 shows the results of a typical experiment to measure IC₅₀ using a sample processing apparatus SPA as depicted in FIG. 2. The pumps contained the following:
P_{A}: inhibitor+tracer dye (ALEXA FLUOR 700™, Invitrogen, Carlsbad, Calif., USA)+enzyme substrate+buffer
P_{B}: enzyme substrate+buffer
P_{C}: coupling enzymes+target enzyme+resazurin (also from Invitrogen)
   The tracer dye is added to the solution containing the inhibitor such that measurement of the concentration of ALEXA FLUOR 700™ in the solution reports the concentration of the inhibitor, so long as the inhibitor does not adsorb to the walls of the microfluidic chip. If adsorption occurs, the concentration of the inhibitor will vary in expected ways, as discussed below. Resazurin is a non-fluorescent precursor that is converted to highly fluorescent resorufin by the action of the target enzyme and the coupling enzymes. The pump flow rates varied as follows:

| | 1300 to 1380 | 1380 to 1560 | 1560 to 1780 |
|---|---|---|---|
| Pump | seconds | seconds | seconds |
| P_{A} | 15 nl/min | Decrease to | 0 nl/min |
| | | 0 nl/min | |
| P_{B} | 0 nl/min | Increase to | 15 nl/min |
| | | 15 nl/min | |
| P_{C} | 15 nl/min | 15 nl/min | 15 nl/min |

The complimentary actions of pumps P_{A} and P_{B} create a concentration gradient of inhibitor and tracer dye at mixing point 1, MP1, which then travels to mixing point 2, MP2, where it is combined with the target enzyme.

Considering again FIG. 6, tracer plot TP is the fluorescence measured from the tracer dye (ALEXA FLUOR 700™) that was mixed with the inhibitor, so the concentration of the inhibitor should mirror the concentration of the tracer dye. Enzyme plot EP is the fluorescence measured from a product (resorufin) of the coupled enzyme system, so it indicates the activity of the target enzyme. The dashed lines indicate the beginning of data extraction BDE and end of data extraction EDE as identified by an automated data extraction routine that delineates the region of data that is used for determining the IC₅₀ of the inhibitor. Thus, in this example, the concentration of the inhibitor is initially high and decreases to zero over the region labeled as declining gradient DG. The activity of the enzyme increases, as evident by the rise in enzyme plot EP, as the inhibitor concentration decreases; however, the activity continues to rise, even after the tracer dye reaches zero. In fact, enzyme plot EP continues to rise until the end of the experiment at the end of the data extraction EDE. This continuing rise in enzyme plot EP indicates that the concentration of the inhibitor continues to decrease even after tracer plot TP has reached zero.

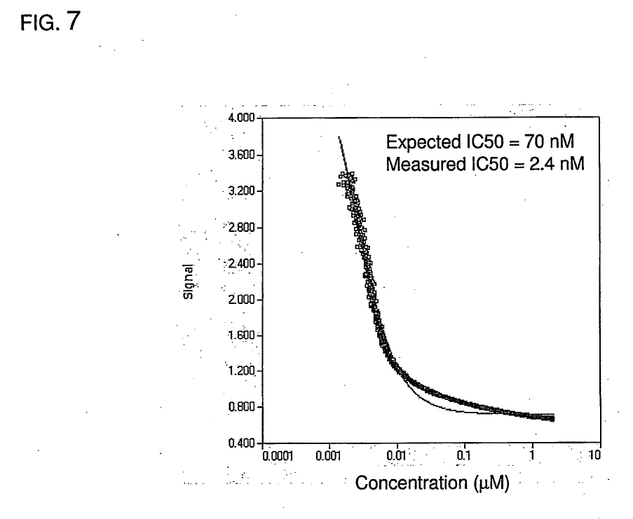

FIG. 7 presents the data from FIG. 6 transformed to concentration: versus enzyme activity—the format used to determine an inhibitor's IC₅₀. The x-axis is the concentration of the inhibitor, as reported by the tracer dye which is tracer plot TP in FIG. 6. The y-axis is the enzyme activity as reported by enzyme plot EP in FIG. 6. The data at inhibitor concentrations less than about 0.007 μM are meaningless, because this is the lowest concentration that can be measured from tracer plot TP. Thus, the IC₅₀ of this inhibitor can not be determined from this data.

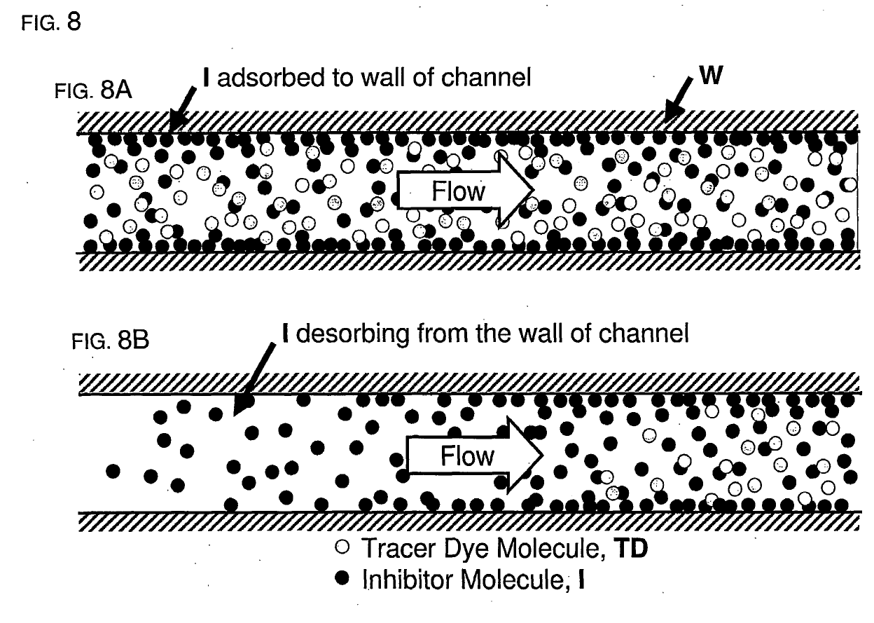

As presented in FIGS. 8A and 8B, the poor measurement depicted in FIGS. 6 and 7 can be explained by compound adsorption to the surface of the microfluidic channels. The effect of adsorption/desorption is that the concentration of the inhibitor in the volume is no longer known. Such phenomena have been modeled in several reports (e.g. (Madras et al., 1996; Balasubramanian et al., 1997; Sharma et al., 2005)). As discussed earlier, adsorption of hydrophobic molecules frequently occurs to a surface that is hydrophobic. The chip used in the experiment for FIGS. 6 and 7 was made from the same polycarbonate material used for the experiments in FIG. 5. The chip for this experiment was not treated, so the surface of the microchannels was hydrophobic (surface energy ˜40 dyne/cm). The inhibitor tested in FIG. 6 has a logP of about 6.7, indicating that it is very hydrophobic, so adsorption of this compound to the surface of the microchannels is expected.

### Example 3

### IC₅₀ Determination Using a Treated SPA

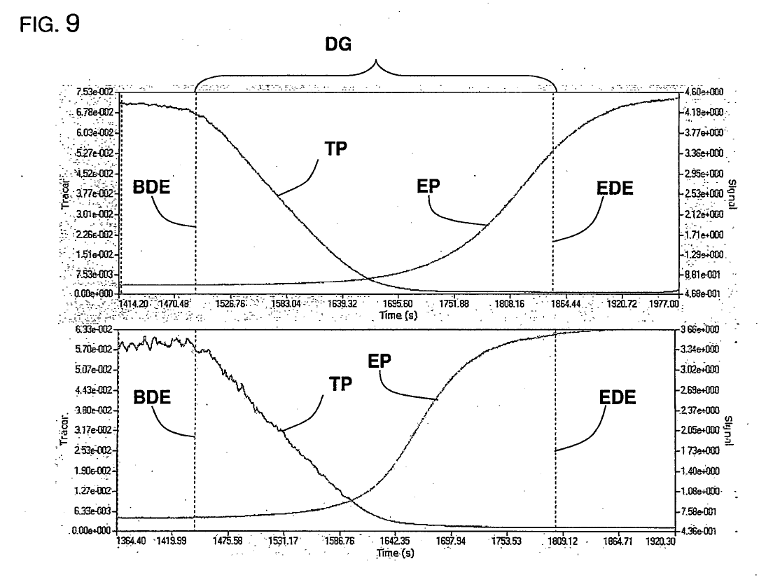

FIG. 9 shows the data from an experiment identical to that described above in Example 2, with the exception that the experiment whose data is reported in FIG. 9 was performed in a microfluidic chip that had been treated by the method of the presently disclosed subject matter. The upper graph of FIG. 9 is the data from FIG. 6 redrawn for ease of comparison. The lower graph is data from the experiment in treated microfluidic chip MFC. Most notably, enzyme plot EP in the lower graph rises to full activity more quickly than in the upper graph, indicating that the inhibitor concentration decreases more quickly, as expected if adsorption has been reduced in the experiment for the lower graph.

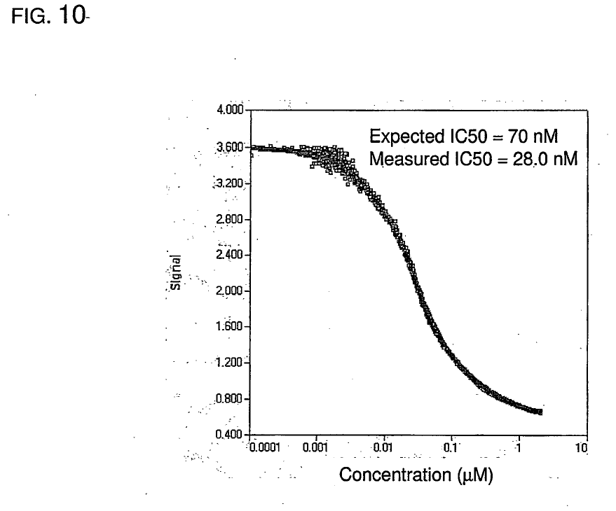

FIG. 10 presents the data from the lower graph of FIG. 9 transformed to concentration versus enzyme activity to determine the inhibitor's IC₅₀. The x-axis is the concentration of the inhibitor, as reported by the tracer dye, which is tracer plot TP in the lower graph of FIG. 9. The y-axis is the enzyme activity as reported by enzyme plot EP in the lower graph of FIG. 9. The inhibitor concentrations down to 0.0001 μM are now meaningful (compare to FIG. 7) because the inhibitor concentration is now accurately reported by tracer plot TP. Not only can the IC₅₀ be determined from this data, but the IC₅₀ is sufficiently near the expected value (28 nM measured versus 70 nM expected) that it is within normal bounds for experiment-to-experiment variation. Thus, this experiment (lower graph of FIG. 9 and FIG. 10) demonstrates that the adsorption evident in FIGS. 6 and 7 is now not apparent.

### REFERENCES

Andersson, H., van der, W. W., Griss, P., Niklaus, F., Stemme, G. (2001). Hydrophobic valves of plasma deposited octafluorocyclobutane in DRIE channels. Sensors & Actuators B-Chemical 75, 136-141.
Auerswald, J., Linder, V., Knapp, H. F. (2004). Evaluation of a concept for on-chip biochemical assay based on dielectrophoresis-controlled adhesion of beads. Microelectronic Engineering 73-74, 822-829.
Balasubramanian, V., Jayaraman, G., Iyengar, S. R. K. (1997). Effect of secondary flows on contaminant dispersion with weak boundary absorption. Applied Mathematical Modelling 21, 275-285.
Bayiati, P., Tserepi, A., Gogolides, E., Misiakos, K. (2004). Selective plasma-induced deposition of fluorocarbon films on metal surfaces for actuation in microfluidics. Journal of Vacuum Science & Technology A-Vacuum Surfaces & Films 22, 1546-1551.
Becker, H., Gartner, C. (2000). Polymer Microfabrication Methods for Microfluidic Analytical Applications. Electrophoresis 21, 12-26.
Becker, H., Locascio, L. E. (2002). Polymer microfluidic devices. Talanta 56, 267-287.
Bevan, M. A., Prieve, D. C. (2000). Forces and hydrodynamic interactions between polystyrene surfaces with adsorbed PEO-PPO-PEO. Langmuir 16, 9274-9281.
Bohner, M., Ring, T. A., Rapoport, N., Caldwell, K. D. (2002). Fibrinogen adsorption by PS latex particles coated with various amounts of a PEO/PPO/PEO triblock copolymer. J. Biomater. Sci. Polym. Ed 13, 733-746.
Brandani, P., Stroeve, P. (2003). Adsorption and desorption of PEO-PPO-PEO triblock copolymers on a self-assembled hydrophobic surface. Macromolecules 36, 9492-9501.
Bridgett, M. J., Davies, M. C., Denyer, S. P. (1992). Control of staphylococcal adhesion to polystyrene surfaces by polymer surface modification with surfactants. Biomaterials 13, 411-6.
Bromberg, L., Salvati, L., Jr. (1999). Bioactive surfaces via immobilization of self-assembling polymers onto hydrophobic materials. Bioconjug. Chem. 10, 678-686.
Carstens, P. A. B., Marais, S. A., Thompson, C. J. (2000). Improved and novel surface fluorinated products. Journal of Fluorine Chemistry 104, 97-107.
Cheng, J. Y., Wei, C. W., Hsu, K. H., Young, T. H. (2004). Direct-write laser micromachining and universal surface modification of PMMA for device development. Sensors & Actuators B-Chemical 99, 186-196.
Davidson, C. A. B., Lowe, C. R. (2004). Optimisation of polymeric surface pre-treatment to prevent bacterial biofilm formation for use in microfluidics. Journal of Molecular Recognition 17, 180-185.
De Cupere, V. M., Biltresse, S., Marchand-Brynaert, J., Rouxhet, P. G. (2003). Radiolabeling of Pluronic amphiphilic copolymer for adsorption studies. J. Colloid Interface Sci. 259, 163-170.
Desai, N. P., Hubbell, J. A. (1991a). Biological responses to polyethylene oxide modified polyethylene terephthalate surfaces. J. Biomed. Mater. Res. 25, 829-843.
Desai, N. P., Hubbell, J. A. (1991b). Solution technique to incorporate polyethylene oxide and other water-soluble polymers into surfaces of polymeric biomaterials. Biomaterials 12, 144-153.
Desai, N. P., Hubbell, J. A. (1992). Surface physical interpenetrating networks of poly(ethylene terephthalate) and poly(ethylene oxide) with biomedical applications. Macromolecules 25, 226-32.
Desai, N. P., Hossainy, S. F. A., Hubbell, J. A. (1992). Surface-immobilized polyethylene oxide for bacterial repellence. Biomaterials 13, 417-420.
Desai, N. P., Hubbell, J. A. (1991c). Solution technique to incorporate polyethylene oxide and other water-soluble polymers into surfaces of polymeric biomaterials. Biomaterials 12, 144-153.
Detrait, E., Lhoest, J. B., Bertrand, P., van den Bosch de Aguilar (1999). Fibronectin-pluronic coadsorption on a polystyrene surface with increasing hydrophobicity: relationship to cell adhesion. J. Biomed. Mater. Res. 45, 404-413.
Dewez, J. L., Berger, V., V, Schneider, Y. J., Rouxhet, P. G. (1997). Influence of Substrate Hydrophobicity on the Adsorption of Collagen in the Presence of Pluronic F68, Albumin, or Calf Serum. J. Colloid Interface Sci. 191, 1-10.
Dewez, J. L., Schneider, Y. J., Rouxhet, P. G. (1996). Coupled influence of substratum hydrophilicity and surfactant on epithelial cell adhesion. J. Biomed. Mater. Res. 30, 373-383.
Dixon, D. D., Manly, D. G., Recktenwald, G. W. Process for Producing Blow Molded Thermoplastic Articles Having Improved Barrier Properties. Air Products and Chemicals, Inc. U.S. Pat. No. 3,862,284. 1975. USA.
Doherty, E. A., Meagher, R. J., Albarghouthi, M. N., Barron, A. E. (2003). Microchannel wall coatings for protein separations by capillary and chip electrophoresis. Electrophoresis 24, 34-54.
du Toit, F. J., Sanderson, R. D. (1999). Surface fluorination of polypropylene: 1. Characterisation of surface properties. Journal of Fluorine Chemistry 98, 107-114.
du Toit, F. J., Sanderson, R. D., Engelbrecht, W. J., Wagener, J. B. (1995). The effect of surface fluorination on the wettability of high density polyethylene. Journal of Fluorine Chemistry 74, 43-48.
Ferraria, A. M., Lopes da Silva, J. D., Botelho do Rego, A. M. (2004). Optimization of HDPE direct fluorination conditions by XPS studies. Journal of Fluorine Chemistry 125, 1087-1094.
Green, R. J., Davies, M. C., Roberts, C. J., Tendler, S. J. (1998). A surface plasmon resonance study of albumin adsorption to PEO-PPO-PEO triblock copolymers. J. Biomed. Mater. Res. 42, 165-171.
Henry, A. C., Waddell, E. A., Shreiner, R., Locascio, L. E. (2002). Control of electroosmotic flow in laser-ablated and chemically modified hot imprinted poly(ethylene terephthalate glycol) microchannels. Electrophoresis 23, 791-8.
Joffre, S. P. Impermeable Polyethylene Film and Containers and Process of Making Same. Shulton, Inc. U.S. Pat. No. 2,811,468. 1957. USA.
Kharitonov, A. P. (2000) Practical Applications of the Direct Fluorination of Polymers. Journal of Fluorine Chemistry 103, 123-127.
Kharitonov, A. P., Moskvin, Y. (1998). Direct fluorination of polystyrene films. Journal of Fluorine Chemistry 91, 87-93.
Lee, L. P., Berger, S. A., Liepmann, D., Pruitt, L. (1998). High aspect ratio polymer microstructures and cantilevers for biomems using low energy ion beam and photolithography. Sensors & Actuators A-Physical 71, 144-149.
Li, M., Zhai, J., Liu, H., Song, Y. L., Jiang, L., Zhu, D. B. (2003). Electrochemical deposition of conductive superhydrophobic zinc oxide thin films. Journal of Physical Chemistry B 107, 9954-9957.
Liu, J., Hansen, C., Quake, S. R. (2003). Solving the “World-to-Chip” Interface Problem with a Microfluidic Matrix. Analytical Chemistry 75, 4718-4723.
Liu, V. A., Jastromb, W. E., Bhatia, S. N. (2002). Engineering protein and cell adhesivity using PEO-terminated triblock polymers. J. Biomed. Mater. Res. 60, 126-134.
Locascio, L. E., Perso, C. E., Lee, C. S. (1999). Measurement of electroosmotic flow in plastic imprinted microfluid devices and the effect of protein adsorption on flow rate. J Chromatogr A 857, 275-84.
Madras, G., Hamilton, B. L., Matthews, M. A. (1996). Influence of adsorption on the measurement of diffusion coefficients by taylor dispersion. International Journal of Thermophysics 17, 373-389.
McDonald, J. C., Whitesides, G. M. (2002). Poly(dimethylsiloxane) as a Material for Fabricating Microfluidic Devices. Accounts of Chemical Research 25, 491-499.
Moon, H., Cho, S. K., Garrell, R. L., Kim, C. J. (2002). Low voltage electrowetting-on-dielectric. Journal of Applied Physics 92, 4080-4087.
Musoke, M., Luckham, P. E. (2004). Interaction forces between polyethylene oxide-polypropylene oxide ABA copolymers adsorbed to hydrophobic surfaces. Journal of Colloid & Interface Science 277, 62-70.
O'connor, S. M., Deanglis, A. P., Gehrke, S. H., Retzinger, G. S. (2000). Adsorption of plasma proteins on to poly(ethylene oxide)/poly(propylene oxide) triblock copolymer films: a focus on fibrinogen. Biotechnol. Appl. Biochem. 31 (Pt 3), 185-196.
Ouellette, J. (2003). A New Wave of Microfluidic Devices. The Industrial Physicist August/September, 14-17.
Quake, S. R., Scherer, A. (2000). From Micro- to Nanofabrication with Soft Materials. Science 290, 1536-1539.
Rolland, J. P., Van Dam, R. M., Schorzman, D. A., Quake, S. R., DeSimone, J. M. (2004). Solvent-resistant photocurable liquid fluoropolymers for microfluidic device fabrication [corrected]. [erratum appears in J Am Chem Soc. 2004 Jul. 7; 126(26): 8349]. Journal of the American Chemical Society 126, 2322-2323.
Rossier, J. S., Gokulrangan, G., Girault, H. H., Svojanovsky, S., Wilson, G. S. (2000). Characterization of Protein Adsorption and Immunosorption Kinetics in Photoablated Polymer Microchannels. Langmuir 16, 8489-8494.
Sharma, U., Gleason, N. J., Carbeck, J. D. (2005). Diffusivity of solutes measured in glass capillaries using Taylor's analysis of dispersion and a commercial CE instrument. Analytical Chemistry 77, 806-813.
Tan, J. S., Butterfield, D. E., Voycheck, C. L., Caldwell, K. D., Li, J. T. (1993). Surface modification of nanoparticles by PEO/PPO block copolymers to minimize interactions with blood components and prolong blood circulation in rats. Biomaterials 14, 823-33.
Thorsen, T., Maerkl, S. J., Quake, S. R. (2002). Microfluidics Large-Scale Integration. Science 298, 580-584.
Unger, M. A., Chou, H-P., Thorsen, T., Scherer, A., Quake, S. R. (2000). Monolithic Microfabricated Valves and Pumps by Multilayer Soft Lithography. Science 288, 113-116.
Webb, K., Caldwell, K. D., Tresco, P. A. (2001). A novel surfactant-based immobilization method for varying substrate-bound fibronectin. J Biomed Mater Res 54, 509-18.
Wood, C. D., Michel, U., Rolland, J. P., DeSimone, J. A. (2004). Newfluoropolymer materials. Journal of Fluorine Chemistry 125, 1671-1676.
Yang, H. and Sundberg, S. A. Surface coating for microfluidic devices that incorporate a biopolymer resistant moiety. Technologies, Caliper. U.S. Pat. No. 6,326,083. 2001. USA.

It will be understood that various details of the subject matter disclosed herein may be changed without departing from the scope of the subject matter. Furthermore, the foregoing description is for the purpose of illustration only, and not for the purpose of limitation.

1. A method of treating a plastic surface to decrease adsorption of hydrophobic solutes to the surface, the method comprising contacting the surface with a first gas comprising fluorine gas and a second gas comprising one or more of oxygen gas and water vapor, wherein treating the surface decreases adsorption of hydrophobic solutes to the surface as compared to a comparable untreated surface.

2. The method of claim 1, wherein the first and second gases are mixed and the surface is treated with the first gas and the second gas simultaneously.

3. The method of claim 1, wherein the surface is treated with the first gas and then the second gas in sequence.

4. The method of claim 1, wherein the plastic is selected from the group consisting of a polyolefin, a polyaryl, a polyester, a polyamide, a polyurethane, a polyether, a polysulfone, a silicone, a polycarbonate, and combinations thereof.

5. The method of claim 4, wherein the plastic is selected from the group consisting of polycarbonates, polyesters, polyamides, polyethers, and cyclic olefin copolymers.

6. The method of claim 1, wherein the hydrophobic solutes have clogP values equal to or greater than about 3.

7. The method of claim 1, wherein the hydrophobic solutes are known or potential drug molecules.

8. The method of claim 1, wherein the hydrophobic solutes are solutes of aqueous solutions.

9. The method of claim 1, wherein the hydrophobic solutes are solutes of solutions comprising organic solvents.

10. The method of claim 1, wherein the first gas comprises from about 0.5% to about 10% fluorine gas by volume.

11. The method of claim 1, wherein the first gas comprises from about 1% to about 5% fluorine gas by volume.

12. The method of claim 1, wherein the first gas comprises fluorine gas and an inert gas.

13. The method of claim 12, wherein the inert gas is selected from the group consisting of helium, argon, nitrogen, neon, krypton, and xenon.

14. The method of claim 12, wherein the first gas comprises about 5% fluorine gas and about 95% of the inert gas by volume.

15. The method of claim 12, wherein the first gas comprises about 1% fluorine gas and about 99% of the inert gas by volume.

16. The method of claim 1, wherein the second gas is air.

17. The method of claim 1, wherein the plastic surface is treated with the first and second gases at a temperature of between about 20° C. and about 25° C.

18. The method of claim 3, wherein the surface is treated with the first gas for a period of time ranging from about one minute to about 25 minutes.

19. The method of claim 18, wherein the surface is treated with the first gas for a period of time ranging from about one minute to about four minutes.

20-31. (canceled)

32. A plastic article comprising one or more treated surfaces, the treated surfaces prepared by sequential treatment with a first gas comprising fluorine gas and a second gas comprising one or more of oxygen gas and water vapor such that the treated surface has a reduced capacity for adsorption of hydrophobic solutes.

33-39. (canceled)

40. A microfluidic chip comprising at least one microfluidic channel comprising a treated interior plastic surface having a reduced capacity for the adsorption of hydrophobic solutes as compared to a comparable untreated plastic surface, the treated interior plastic surface treated according to the method of claim 1.

41-62. (canceled)
